(19) United States
(12) Patent Application Publication
(10) Pub. No.: US 2021/0350325 A1
(43) Pub. Date: Nov. 11, 2021

(54) GENERATING AND PROVIDING RELEVANT CONTENT UPDATES

(71) Applicant: Dropbox, Inc., San Francisco, CA (US)

(72) Inventors: Christina Holden, San Francisco, CA (US); Royce Ausburn, Mountain View, CA (US); Antoinette Huelskamp, San Francisco, CA (US)

(21) Appl. No.: 16/869,133

(22) Filed: May 7, 2020

(51) Int. Cl. G06Q 10/10

(52) U.S. Cl. CPC G06Q 10/103

(57) ABSTRACT

The present disclosure is directed toward systems, methods, and non-transitory computer readable media for generating and providing a digital space report indicating relevant digital content items with respect to a particular user from a collaborative digital team space. For example, the systems described herein can determine that a collaborative digital team space is flagged for providing updates to a particular user. The disclosed systems can also identify content relevance indicators for digital content items within the flagged collaborative digital team space. In addition, the disclosed systems can generate a digital space report to provide to a client device of the user and that indicates updates for relevant digital content items.

### BACKGROUND

Advancements in computing devices and networking technology have led to a variety of innovations in providing collaborative environments for users to manage digital content as a group. For example, online digital content systems are now able to synchronize changes to digital content across devices nearly instantaneously so that users all over the world can work together within a single environment. Indeed, whether in education, employment, or elsewhere, modern online digital content systems are able to provide simultaneous access to digital content for users to collaborate together regardless of physical location of the users.

Despite these advances, conventional digital content systems continue to suffer from a number of disadvantages, particularly in their efficiency and flexibility. For instance, conventional digital content systems inefficiently utilize computing resources such as processing time and power, storage space, and communication bandwidth when notifying users of changes made to files synchronized within the digital content system. Indeed, conventional systems often generate and distribute excessive numbers of digital communications to user devices in attempts to keep user's up-to-date to changes made to files. For example, many conventional systems generate and provide individual emails to each user device for updates or changes made to a file within a collaborative group, thus inundating user devices, inboxes, and servers with a huge amount of information that is often irrelevant to users. These problems are especially pronounced in cases where collaborative groups include particular users who may not even be involved in a given project associated with the changes but may still receive notifications for changes made relative to the project.

Beyond the onerous computing costs of generating and processing excessive numbers of digital communications, many conventional systems also result in inefficient graphical user interfaces that often require an excessive number of user interactions for a user to locate relevant information. For example, a conventional system that provides notifications for all of the changes made to certain files requires a client device or a server to process user interactions with each of the notifications to, for instance, view changes relevant to a particular user. Indeed, especially for mobile devices where screen space is particularly limited, filling inboxes and/or notification centers with large numbers of irrelevant digital communications can make navigating through such inboxes and/or notification centers time consuming and input-intensive. Moreover, having to navigate through the large numbers of communications also provides an inefficient graphical user interface experience to a user that makes it difficult for a user to ultimately locate and access pertinent information that may be hidden amongst the mass of irrelevant communications.

In addition to being inefficient, conventional digital content systems are also inflexible. More specifically, conventional digital content systems provide general updates to client devices, irrespective of particular user device activity and regardless of user interest or involvement in particular digital content. Indeed, upon detecting a change or an update to a file, a conventional system rigidly provides a universal notification to all user devices associated with the file, even when some of the user devices may be associated with users that may not have any interest in the file or even be involved with the creation or editing of the file.

Thus, there are several disadvantages with regard to conventional digital content systems.

### SUMMARY

One or more implementations described herein provide benefits and solve one or more of the foregoing or other problems in the art by providing systems, methods, and non-transitory computer readable media that can generate and provide digital space reports that include interactive content item elements for digital content items that are relevant to a client device (e.g., a user associated with the client device). In particular, the disclosed systems can identify digital content items that are relevant to a client device from among any number of digital content items within a collaborative digital team space and can provide links to the relevant digital content items in a consolidated, efficient, and personalized space report interface.

For example, the disclosed systems can generate a digital space report that indicates to a user in a concise manner which digital content items are most relevant based on various content relevance indicators. Indeed, the disclosed systems can determine various content relevance indicators that indicate a relevance of a content item to a particular user associated with a client device. In addition, the system can use the various content relevance indicators to generate a customized relevance score corresponding to a content item and with respect to the particular user. Indeed, based on the customized and personalized content relevance indicators and relevance scores, the disclosed systems can determine that changes to a particular content item are relevant to a first user, but those changes are not relevant to a second user. Accordingly, based on determining the most relevant content for a particular user, the disclosed systems can generate a digital space report that allows the particular user to easily view and/or otherwise access the relevant content items while not providing information for content items that the particular user would not find relevant.

Additional features and advantages of the present application will be set forth in the description which follows, and in part will be obvious from the description, or may be learned by the practice of such example implementations.

### BRIEF DESCRIPTION OF THE DRAWINGS

This disclosure will describe one or more implementations of the invention with additional specificity and detail by referencing the accompanying figures. The following paragraphs briefly describe those figures, in which:

FIG. 1 illustrates a schematic diagram of an example environment of a digital space report system in accordance with one or more implementations;

FIG. 2 illustrates an overview of generating and providing a digital space report in accordance with one or more implementations;

FIG. 3 illustrates sequences of acts for generating relevance scores for digital content items in accordance with one or more implementations;

FIG. 4 illustrates generating digital space reports for users in accordance with one or more implementations;

FIG. 5 illustrates training a relevance machine learning model to determine relevance scores in accordance with one or more implementations;

FIG. 6 illustrates applying a relevance machine learning model to determine relevance scores of digital content items in accordance with one or more implementations;

FIG. 7 illustrates flagging an example space report interface in accordance with one or more implementations;

FIG. 8 illustrates an example multi-space report summary interface in accordance with one or more implementations;

FIG. 9 illustrates an example space report interface in accordance with one or more implementations;

FIG. 10 illustrates an example space report interface in accordance with one or more implementations;

FIGS. 11A-11B illustrate an example space report interface in accordance with one or more implementations;

FIG. 12 illustrates a schematic diagram of a digital space report system in accordance with one or more implementations;

FIG. 13 illustrates flowcharts of series of acts in methods of generating and providing a digital space report in accordance with one or more implementations;

FIG. 14 illustrates a block diagram of an exemplary computing device in accordance with one or more implementations; and

FIG. 15 illustrates an example environment of a networking system having the digital space report system in accordance with one or more implementations.

### DETAILED DESCRIPTION

One or more implementations described herein provide benefits and solve one or more of the foregoing or other problems in the art with a digital space report system that can generate and provide digital space reports including interactive digital content elements for user-specific relevant digital content items from a collaborative digital team space within a content management system. Particularly, the digital space report system can identify one or more collaborative digital team spaces associated with a user, where each collaborative digital team space includes one or more digital content items. Within each collaborative digital team space, the digital space report system can determine which digital content items are relevant to the user based on various content relevance indicators (e.g., access of digital content items by the user, access of digital content items by frequent collaborators of the user, numbers of updates or modifications made to digital content items, as well as other indicators as described in more detail below).

Based on identifying relevant digital content items from a given collaborative digital team space and for a specific user, the digital space report system can further generate a digital space report to provide to a client device associated with the user. The digital space report can include interactive content item elements, and upon receiving an indication of a user interaction with one or more interactive content item elements within the digital space report, the digital space report system can provide access to the corresponding relevant digital content items specific to the user. Additionally, the digital space report system can exclude (or refrain from including) content item elements for digital content items that are not relevant (or that are less relevant) to the user.

As mentioned, the digital space report system can identify collaborative digital team spaces associated with a user. In particular, the digital space report system can identify collaborative digital team spaces that include collections of digital content items. To identify collaborative digital team spaces that are associated with a particular user (or a particular client device), the digital space report system can determine that the user (or the client device) has access to the collaborative digital team space. Indeed, the digital space report system can manage or maintain large numbers of collaborative digital team spaces, each with its own digital content items accessible by different teams of users (or client devices). Thus, the digital space report system facilitates collaborative editing, modifying, commenting, sharing, and other types of interaction with digital content items of the various collaborative digital team spaces by those users with permission to access the collaborative digital team space.

In addition to identifying one or more collaborative digital team spaces that are associated with a user, the digital space report system can further identify flagged collaborative digital team spaces. To elaborate, the digital space report system can identify or receive a user interaction starring, selecting, or otherwise flagging a collaborative digital team space. Based on determining that a user has flagged a collaborative digital team space, the digital space report system can determine that the flagged collaborative digital team space is significant or of interest to the user. Thus, the digital space report system can determine to provide digital content item updates to the user for one or more digital content items within the flagged collaborative digital team space.

Indeed, the digital space report system can provide updates for digital content items within a flagged collaborative digital team space. In particular, the digital space report system can identify relevant digital content items (e.g., digital content items that are relevant with respect to the user) within the flagged collaborative digital team space and can provide updates for those digital content items. For example, the digital space report system can generate and provide a digital space report for the flagged collaborative digital team space that summarizes or highlights updates for relevant digital content items—e.g., to quickly catch the user up on any modifications, comments, or other activity associated with the relevant digital content items.

To identify relevant digital content items, the digital space report system can determine relevance scores for digital content items with respect to the user. In some implementations, the digital space report system determines content relevance indicators for individual digital content items that indicate measures of relevance of the digital content items with respect to the user. For example, the digital space report system can determine content relevance indicators such as a frequency (or a number of times) with which the user accesses a given digital content item, a frequency (or a number of times) that other users with access to the flagged collaborative digital team space access the digital content item, a number of comments within a digital content item, and/or a number of modifications made to a digital content item since a last access by the user, among others as discussed in further detail below. In addition, the digital space report system can weight content relevance indicators for a particular digital content item to determine a relevance score for the digital content item. Additional detail regarding the content relevance indicators and determining relevance scores for digital content items is provided below with reference to the figures.

As mentioned, the digital space report system can generate and provide a digital space report to inform a user about updates (e.g., modifications, comments, or other user activity) for relevant digital content items within the flagged collaborative digital team space. Indeed, the digital space report system can generate a digital space report specific to the flagged collaborative digital team space and can include within the digital space report selectable content item elements for relevant digital content items. For example, the digital space report system can provide the digital space report for display within a space report interface on a client device of the user, where the digital space report includes selectable content item elements corresponding to relevant digital content items within the flagged collaborative digital team space.

Additionally, the digital space report system can identify multiple flagged collaborative digital team spaces for the user. In particular, the digital space report system can determine that the user has starred, selected, or otherwise flagged two or more collaborative digital team spaces for receiving updates. Thus, the digital space report system can further determine relevance scores for digital content items within the flagged collaborative digital team spaces to identify relevant digital content items with respect to the user. The digital space report system can further generate and provide a multi-space report summary interface to summarize updates for the relevant digital content items within each flagged collaborative digital team space. Within the multi-space report summary interface, the digital space report system can include team space elements selectable to view digital space reports for the respective flagged collaborative digital team spaces.

In addition to the identifying multiple flagged collaborative digital team spaces, the digital space report system can further generate different digital space reports for different users for the same flagged collaborative digital team space. Indeed, the digital space report system can determine that two users have flagged the same collaborative digital team space for receiving updates and can determine different relevance scores for digital content items within the flagged collaborative digital team space for the different users. Based on the different relevance scores relative to the two users, the digital space report system can generate a first digital space report for the first user based on a first set of relevant digital content items (relevant to the first user) and can generate a second digital space report for the second user based on a second set of relevant digital content items (relevant to the second user) different from the first set of relevant digital content items.

In some implementations, the digital space report system can generate a digital space report to indicate updates for relevant digital content items over a particular time period. In particular, the digital space report system can identify updates that occur for individual digital content items over a day, a week, six months, or a year (or some other time period). Thus, by identifying relevant digital content items relative to a user and generating a digital space report to summarize the updates for those relevant digital content items such as modifications, comments, shares, accesses, or other item-specific user activity that occurred over the time period, the digital space report system condenses a large amount of information into a more consumable, single digital communication with which a user can easily access desired content with a minimal number of user interactions.

Further, the digital space report system can identify users, content items, or other activity within a collaborative digital team space to highlight within a digital space report. For example, the digital space report system can monitor user activity (e.g., collaborative digital team space information) to determine which users make the most modifications to digital content items, accomplish the most to-do items, share the most items, create a digital content item that receives the most comments, or that performs some other superlative action. Based on monitoring the user activity, the digital space report system can generate a digital space report to include spotlight elements to indicate the accomplishments of various users.

As suggested above, the digital space report system provides several advantages over conventional digital content systems. For example, the digital space report system is more efficient than conventional systems. Specifically, the digital space report system can utilize fewer computing resources such as processing power, processing time, and digital storage by processing and distributing fewer digital communications. Whereas conventional systems generate and distribute large amounts of update-specific digital communications to notify users of individual content updates (thereby wasting computing resources), the digital space report system can more efficiently determine relevant content items for users and groups relevant content updates together, thereby reducing the number of digital communications to process and distribute by eliminating those for irrelevant digital content items and grouping those for relevant digital content items together. The digital space report system can thus alleviate (or reduce) the burden of large numbers of irrelevant digital communications experienced by many users which conventionally fill digital inboxes and/or notification centers and unduly burden communication servers.

Due at least in part to consolidating relevant content updates into fewer digital communications, the digital space report system can further improve the efficiency of client devices by reducing the number of user interactions required to access desired data and/or functionality. While many conventional digital content systems require large numbers of user inputs or interactions to select between individual content-update-specific notifications to either access them or delete them, the digital space report system can require fewer user interactions. Indeed, the digital space report system can provide a space report interface that includes content item elements selectable to access relevant digital content items from a single location to quickly update the user on the most relevant content updates in fewer interactions (and less screen navigation). As another level of improved efficiency, the digital space report system can provide a multi-space report summary interface that includes team space elements selectable to navigate to multiple flagged collaborative digital team spaces from a single interface.

By providing the space report interface and the multi-space report summary interface, the digital space report system can not only reduce user interactions compared to conventional systems but can also utilize screen space more efficiently. Indeed, the multi-space report summary interface and the space report interface can include update information easily displayed in the limited screen space of a mobile device. For example, the multi-space report summary interface efficiently summarizes content updates within multiple flagged collaborative digital team spaces in a single, mobile-friendly interface. In addition, the space report interface consolidates content updates that conventional systems would distribute individually (which would require onerous user effort on a mobile device to navigate through an inbox) into a single digital communication or a single interface for efficiently accessing relevant updated digital content items.

Beyond improving efficiency over conventional digital content systems, the digital space report system can further improve flexibility over conventional systems. For example, conventional systems often rigidly provide generic content update notifications, irrespective of particular user activity or user interest (e.g. a notification for every content update or notifications for a certain percentage of randomly selected updates). The digital space report system, by contrast, determines digital content items that are relevant with respect to a user and generates a digital space report to notify the user of updates to the relevant digital content items. By thus determining relevance of digital content items, the digital space report system flexibly adapts digital space reports for individual users to only notify the users of updates to digital content items that are relevant to them (and by refraining from inundating the users with irrelevant information). In addition, to further increase flexibility, the digital space report system can monitor a user's interactions with content item elements within a digital space report to further allow the digital space report to more accurately select the most relevant content items for a particular user based on the user's history of selecting content item elements within digital space reports. In other words, the digital space report system is not a “one-size-fits-all” approach, but rather, the digital space report system can flexibly adapt to user-specific idiosyncrasies in determining relevant content items for a specific user.

As illustrated by the foregoing discussion, the present disclosure utilizes a variety of terms to describe features and benefits of the digital space report system. Additional detail is hereafter provided regarding the meaning of these terms as used in this disclosure. As used herein, the term “collaborative digital team space” (or “collaborative team space” or “team space”) refers to a collection of digital content items accessible by one or more users (e.g., accessible by client devices associated with the one or more users). A collaborative digital team space can include a cloud-based storage location that permits access only to particular authorized user accounts and that contains one or more digital content items. In some implementations, a collaborative digital team space is managed by a particular user account which grants access to other user accounts. A collaborative digital team space can include a collection of digital content items, some of which are relevant to one user and not relevant to another user, or more relevant to one user than to another user. A collaborative digital team space can also provide certain functionality to users with access such as commenting, editing, and sharing functionality for the collaborative digital team space and for the digital content items within the collaborative digital team space.

As mentioned, the digital space report system can identify one or more flagged collaborative digital team spaces for a user. As used herein, the term “flagged collaborative digital team space” refers to a collaborative digital team space that has been identified, liked, selected, starred, or otherwise indicated as pertinent, of interest, or significant to a user. The digital space report system can identify a flagged collaborative digital team space based on user interaction selecting or starring the collaborative digital team space as important. In some implementations, the digital space report system automatically (e.g., without user input) identifies a flagged collaborative digital team space based on relevance scores of digital content items within the collaborative digital team space—e.g., by identifying at least a threshold number of digital content items that are relevant to the user.

Relatedly, the term “digital content item” (or “content item”) refers to a digital object or a file that includes information interpretable by a computing device (e.g., a client device) to present information to a user. A digital content item can include a file such as a digital image file, an audio file, a video file, a text file, a spreadsheet file, a web file or some other type of file or digital object. A digital content item can be editable or otherwise modifiable and can also be sharable from one user (or client device) to another (either within a collaborative digital team space or not).

As mentioned, the digital space report system can identify relevant digital content items for a user. As used herein, the term “relevant digital content item” refers to a digital content item with a relevance score that satisfies a relevance threshold. Along similar lines, the term “relevance score” refers to a measure or an indication of a degree of relevance or relatedness to a user. A relevance score can include a rating (e.g., on a scale from 0 to 10 or 0 to 100) of how related or relevant a digital content item is to a user based on various content relevance indicators. Similarly, the term “relevance threshold” refers to a threshold or a minimum score which delineates between relevant digital content item and irrelevant digital content items. For example, digital content items with relevance scores below a relevance threshold are determined to be irrelevant, and digital content items with relevance scores above the relevance threshold are determined to be relevant digital content items.

The digital space report system can modify or adjust relevance thresholds dynamically for individual users based on, among other factors, relevance scores of digital content items. For instance, if all of the analyzed digital content items have relatively low relevance scores, the digital space report system can lower the relevance threshold to nevertheless identify at least a threshold number (e.g., 1 or 3) of digital content items as (comparatively) relevant (e.g., more relevant than others). Conversely, the digital space report system can raise or increase the relevance threshold if the analyzed digital content items have relatively high relevance scores so that the number of relevant digital content items does not exceed a maximum number. Alternatively (or in addition), the digital space report system can select only a particular number of the top-scored digital content items as relevant if all of the relevance scores are high (e.g., satisfy a relevance threshold).

To determine a relevance score for a digital content item, the digital space report system can identify content relevance indicators for the digital content item. As used herein, the term “content relevance indicator” refers to information or data that signifies relevance of a digital content item to a user. In particular, a content relevance indicator can include a user activity (e.g., a user accessed a file), user inactivity (e.g., a user did not access a file), and/or historical user activity and/or inactivity (e.g., frequency of activity or total number of a particular activity within a defined time period). In addition, a content relevance indicator can include an event associated with a digital content (e.g., file creation, file deletion, file modification, file sharing). In some embodiments, the digital space report system can weight content relevance indicators in determining relevance scores, such as weighting more recent events more heavily than less recent events. For example, recent events (e.g., created, modified, shared, collaborated, commented) corresponding to digital content can result in a stronger content relevance indicator compared to events that took place less recent. In some embodiments, the weights can correspond to a lenghth of time since the event took place (e.g., W1 corresponds to an hour since an event, W2 corresponds to over an hour to six hours, W3 corresponds to over sixe hours to 24 hours, W4 corresponds to over one day to three days, and anything older than three days does not get a weight). A content relevance indicator can also include one or more attributes or a characteristics of a digital content item or of an event associated with a digital content item (e.g., a creator of the digital content item, time created, time shared, time last opened, time last modified, last modifying user, content within the digital content item, time of last modification or other attribute that indicates that the digital content item is relevant to the user, as will be discussed in more detail below.

As briefly mentioned, in some implementations, a content relevance indicator can include inactivity on the part of a user—e.g., where the digital space report system determines that a user has not accessed a digital content item for at least a threshold period of time or for at least a threshold number of previously sent digital space reports and that therefore the digital content item is irrelevant (or less relevant) to the user. In these or other implementations, a content relevance indicator can include relationship information associated with users of a collaborative digital team space. For example, the digital space report system can determine higher relevance for digital content items modified by frequent collaborators of the user and/or for digital content items where the user is a team lead of other users who access the digital content item.

Example content relevance indicators for a given digital content item include previous access by a user, previous access by other users with access to the flagged collaborative digital team space, a number of accesses by the user, a number of access by other users with access to the flagged collaborative digital team space, a frequency of access by the user, a frequency of access by other users with access to the flagged collaborative digital team space, a lack or an absence of access or other activity of the user with respect to the digital content item, a relationship between the user and another user with access to the flagged collaborative digital team space, a share (or a number or a frequency of shares) of the digital content item by the user, a share (or a number or a frequency of shares) of the digital content item by another user with access to the flagged collaborative digital team space, a comment (or a number or a frequency of comments) by the user, a comment (or a number or a frequency of comments) by another user with access to the flagged collaborative digital team space, a modification (or a number or a frequency of modifications) by the user, a modification (or a number or a frequency of modifications) by another user with access to the flagged collaborative digital team space, occurrence (or a number or a frequency of occurrences) of the digital content item within a to-do list generated by the user or another user with access to the collaborative digital team space, and/or a recency of creation or addition of the digital content item to the flagged collaborative digital team space.

As mentioned, the digital space report system can weight content relevance indicators for determining relevance scores (to consider multiple content relevance indicators for a single digital content item). To weight the content relevance indicators, the digital space report system can determine collaborative digital team space information associated with a user. As used herein, the term “collaborative digital team space information” refers to user activity, user relationships, or content item attributes that the digital space report system utilizes for weighting different content relevance indicators differently (for a single user and/or for different users). For example, if the user is a team lead overseeing digital content items within a particular flagged collaborative digital team space, the digital space report system can weight sharing activity (e.g., where other users share a digital content item with the user) of a digital content item more heavily than modification activity. If the user is an engineer, on the other hand, the digital space report system can weight the modification activity more heavily. In some implementations, one content relevance indicator can be collaborative digital team space information that affects how the digital space report system weights another content relevance indicator. In addition, the digital space report system can update weights of content relevance indicators for a user based on monitoring selections of content item elements within digital space reports by the user.

As also mentioned, the digital space report system can generate a digital space report based on identifying relevant digital content items. As used herein, the term “digital space report” (or “space report”) refers to a digital communication that includes notifications of relevant digital content items for a user. A digital space report can include a digital communication within a particular tab or section of an application and/or can include a digital communication in the form of an email or other electronic communication (e.g., IM, text message). The digital space report system can present (or provide for display) a digital space report within a “space report interface” that provides information for relevant digital content items from a flagged collaborative digital team space within a single interface on a client device.

A digital space report (and a corresponding space report interface) can include one or more “content item elements” corresponding to respective digital content items and that are selectable for directly accessing the digital content items. A digital space report can also include information for particular digital content items indicating why the digital content item is relevant to the user and/or what updates have occurred with respect to the digital content item to provide an explanation of why the digital space report includes a content item element for the digital content item.

In some implementations, the digital space report system can generate and provide a multi-space report summary interface to notify a user of updates for digital content items within multiple flagged collaborative digital team spaces. As used herein, the term “multi-space report summary interface” refers to a user interface that includes one or more team space elements corresponding to respective flagged collaborative digital team spaces associated with a user. A multi-space report summary interface can also include indicators of numbers of relevant digital content items within each flagged collaborative digital team space that a user can access by selecting the corresponding team space element.

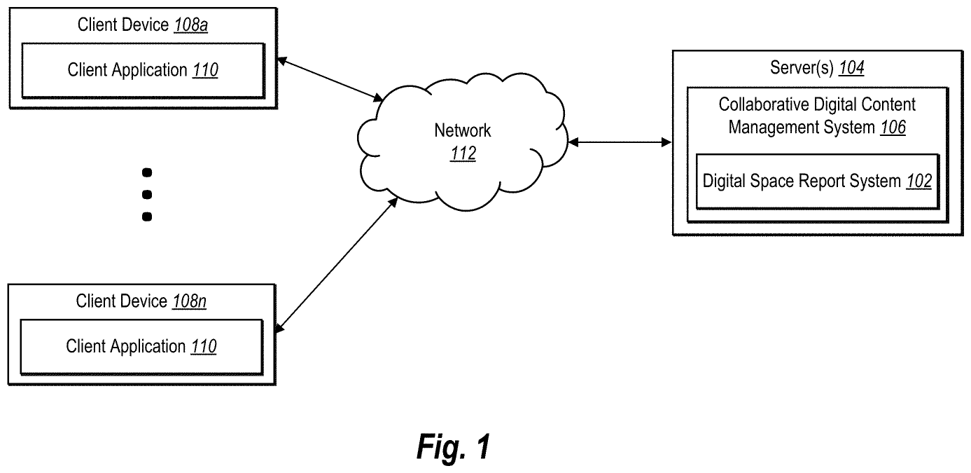

Additional detail regarding the digital space report system will now be provided with reference to the figures. For example, FIG. 1 illustrates a schematic diagram of an example system environment for implementing a digital space report system 102 in accordance with one or more implementations. An overview of the digital space report system 102 is described in relation to FIG. 1. Thereafter, a more detailed description of the components and processes of the digital space report system 102 is provided in relation to the subsequent figures.

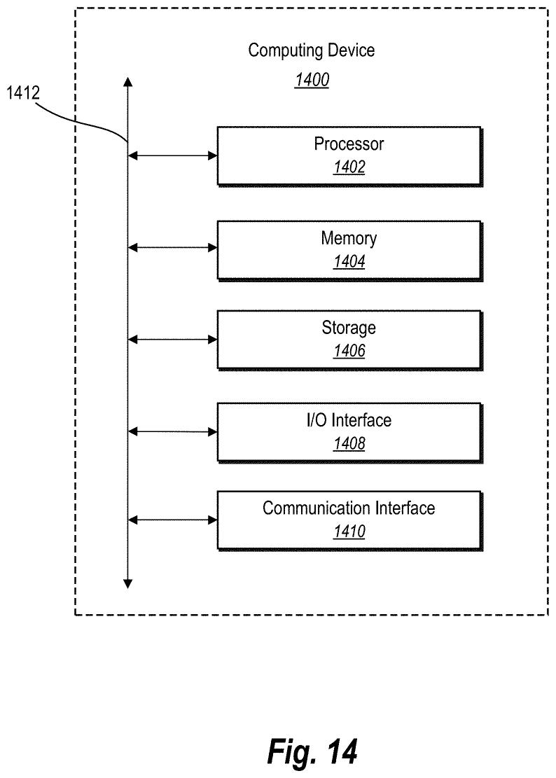

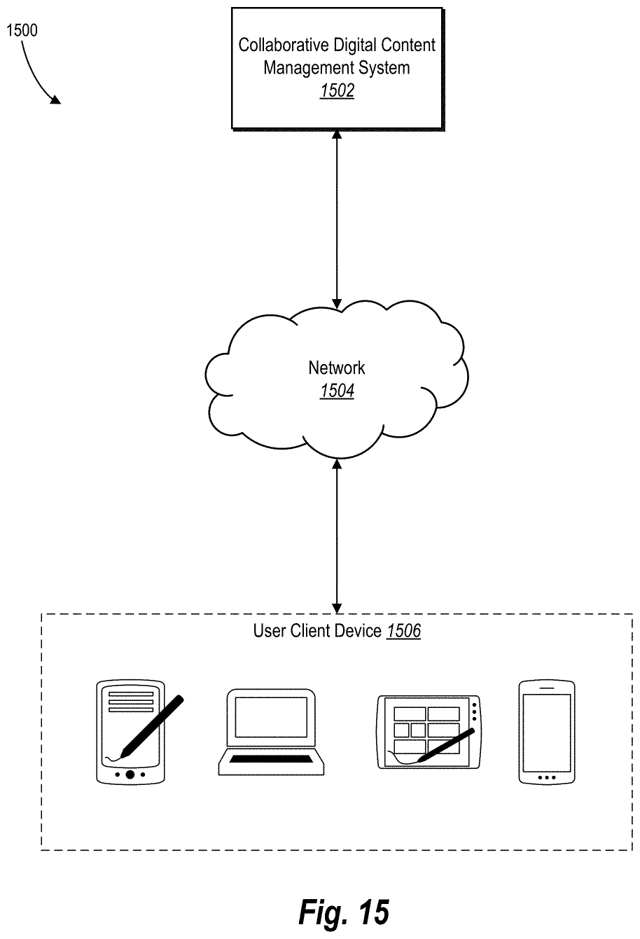

As shown, the environment includes server(s) 104, client devices 108a-108n, and a network 112. Each of the components of the environment can communicate via the network 112, and the network 112 may be any suitable network over which computing devices can communicate. Example networks are discussed in more detail below in relation to FIGS. 14-15.

As mentioned, the example environment includes client devices 108a-108n . The client devices 108a-108n can be one of a variety of computing devices, including a smartphone, a tablet, a smart television, a desktop computer, a laptop computer, a virtual reality device, an augmented reality device, or another computing device as described in relation to FIGS. 14-15. The client devices 108a-108n can communicate with the server(s) 104 via the network 112. For example, the client devices 108a-108n can receive user input from respective users interacting with the client devices 108a-108n (e.g., via the client application 110) to, for example, access, modify, share, or comment on digital content items and/or to interact with content item elements or team space elements. Thus, the digital space report system 102 on the server(s) 104 can receive user activity information relating to various interactions with digital content items and/or user interface elements (e.g., the content item elements or the team space elements) based on the input received by the client devices 108a-108n . In some implementations, users associated with particular client devices 108a-108n (or users associated with a subset of the client devices 108a-108n) can have access to a common collaborative digital team space.

As shown, the client devices 108a-108n include a client application 110. In particular, the client application 110 may be a web application, a native application installed on the client devices 108a-108n (e.g., a mobile application, a desktop application, etc.), or a cloud-based application where all or part of the functionality is performed by the server(s) 104. The client application 110 can present or display information to a user, including a space report interface to present a digital space report or a multi-space report summary interface to summarize updates for multiple flagged collaborative digital team spaces. Additionally, the client application 110 can present information in the form of digital content items and can facilitate user interaction with the digital content items to access, modify, share, and/or comment on the digital content items. A user can interact with the client application 110 to provide user input to perform an operation as mentioned above.

As illustrated in FIG. 1, the example environment includes the server(s) 104. The server(s) 104 may generate, track, store, process, receive, and transmit electronic data, such as content relevance indicators and digital space reports. For example, the server(s) 104 may receive data from the client devices 108a-108n in the form modifications, accesses, shares, or comments of digital content items. In addition, the server(s) 104 can transmit data to the client devices 108a-108n in the form of digital space reports indicating relevant digital content items based on the modifications, accesses, share, comments, and other content relevance indicators as described herein. Indeed, the server(s) 104 can communicate with the client devices 108a-108n to transmit and/or receive data via the network 112. In some implementations, the server(s) 104 comprises a distributed server where the server(s) 104 includes a number of server devices distributed across the network 112 and located in different physical locations. The server(s) 104 can comprise a content server, an application server, a communication server, a web-hosting server, or a machine learning server.

As shown in FIG. 1, the server(s) 104 can also include the digital space report system 102 as part of a collaborative digital content management system 106. The collaborative digital content management system 106 can communicate with the client devices 108a-108n to perform various functions associated with the client application 110 such as managing collaborative digital team spaces including respective collections of digital content items by permitting and denying access to the client devices 108a-108n based on user account permissions, synchronizing modifications, comments, shares, and other digital content item information across the client devices 108a-108n, and facilitating user interaction with the digital content items to modify, comment, and share the digital content items. In addition, the collaborative digital content management system 106 and/or the digital space report system 102 can access and utilize a relevance machine learning model to generate predictions of user access with respect to particular digital content items.

Although FIG. 1 depicts the digital space report system 102 located on the server(s) 104, in some implementations, the digital space report system 102 may be implemented by (e.g., located entirely or in part) on one or more other components of the environment. For example, the digital space report system 102 may be implemented by the client devices 108a-108n and/or a third-party device.

In some implementations, though not illustrated in FIG. 1, the environment may have a different arrangement of components and/or may have a different number or set of components altogether. For example, the client devices 108a-108n may communicate directly with the digital space report system 102, bypassing the network 112. In addition, the environment can include a database located external to the server(s) 104 (e.g., in communication via the network 112) or located on the server(s) 104 and/or located on the client devices 108a-108n and that stores digital content items for one or more collaborative digital team spaces. Additionally, the environment can include one or more relevance machine learning models as part of the digital space report system 102, stored within a database, included as part of the client application 110, or housed on the server(s) 104.

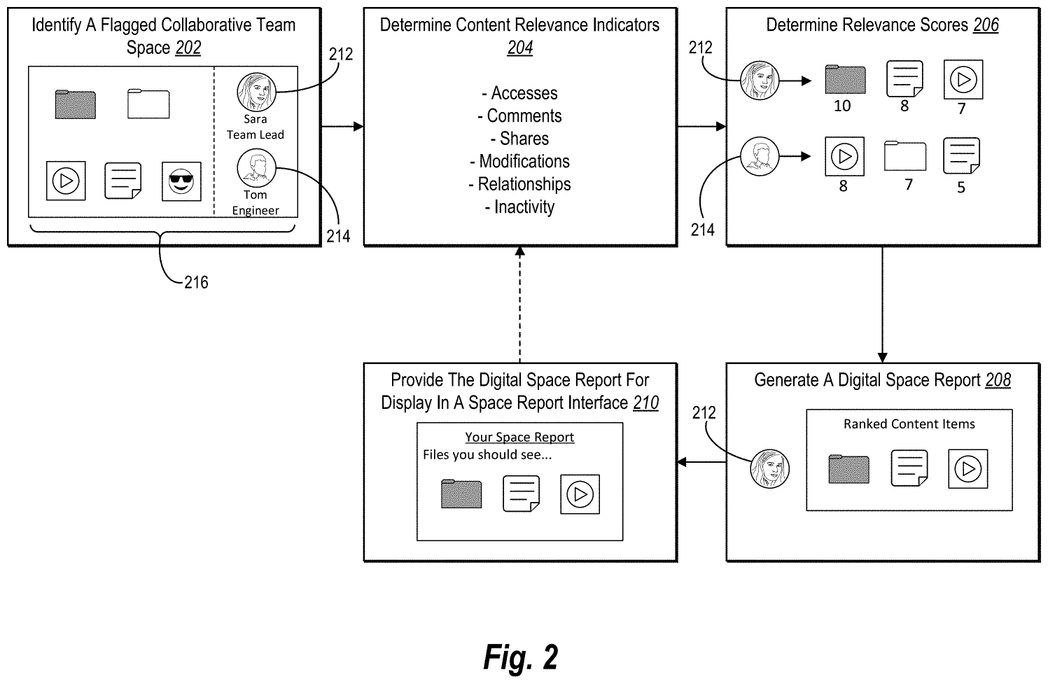

As mentioned, the digital space report system 102 can generate and provide a digital space report to notify a user of updates pertaining to relevant digital content items within a flagged collaborative digital team space. In particular, the digital space report system 102 can identify a collaborative digital team space that a user has flagged (or that is otherwise significant to the user), can determine which digital content items within the flagged collaborative digital team space are relevant to user, and can provide information on any updates that have taken place with respect to the relevant digital content items within a time period (e.g., since a previous digital space report was provided to the user). FIG. 2 illustrates a sequence of acts 202-210 that the digital space report system 102 performs to provide a digital space report to a client device associated with a user (e.g., the client device 108a) in accordance with one or more implementations.

As illustrated in FIG. 2, the digital space report system 102 performs an act 202 to identify a flagged collaborative digital team space 216. In particular, the digital space report system 102 identifies one or more collaborative digital team spaces associated with a user such as any collaborative digital team spaces that the user has permission to access. In addition, the digital space report system 102 identifies a collaborative digital team space that the user has starred or otherwise selected as important or significant. In some implementations, the digital space report system 102 automatically (e.g., without user input) flags a collaborative digital team space by identifying at least a threshold number and/or a threshold frequency of user interactions (e.g., user interactions of the user or of other users with particular relationships with the user such as the user's direct supervisor or direct report(s), or frequent collaborators) with digital content items within the collaborative digital team space.

As shown in FIG. 2, the digital space report system 102 identifies a flagged collaborative digital team space 216 that includes five different digital content items and that is accessible by a first user 212 (“Sara”) and a second user 214 (“Tom”). The five different digital content items resemble files of different types such as a light colored folder, a dark colored folder, a video file, a text file, and a digital image file. As shown, the digital space report system 102 enables both the first user 212 and the second user 214 to access the flagged collaborative digital team space 216 to interact with the digital content items therein. For example, the digital space report system 102 enables the first user 212 and the second user 214 to access, modify, share, or comment on any of the digital content items within the flagged collaborative digital team space 216.

As further shown in FIG. 2, the digital space report system 102 performs an act 204 to determine content relevance indicators. In particular, the digital space report system 102 determines content relevance indicators for the digital content items within the flagged collaborative digital team space 216. For example, the digital space report system 102 determines content relevance indicators for the video file that indicate measures of relevance of the video file with respect to a user (e.g., the first user 212 or the second user 214). Similarly, the digital space report system 102 determines content relevance indicators for the text file, the digital image file, the light colored folder, and the dark colored folder.

More specifically, the digital space report system 102 determines content relevance indicators by identifying particular user activity and/or attributes of digital content items that indicate relevance to a particular user (e.g., the first user 212 or the second user 214). For instance, the digital space report system 102 determines that the first user 212 has accessed the text file numerous times in the recent past and that, therefore, the text file is relevant to the user. Likewise, the digital space report system 102 determines that video file has been shared with the second user 214 and that the second user 214 has not yet accessed the video file. The digital space report system 102 thus determines that the video file is relevant to the second user 214. As another example, the digital space report system 102 determines that the second user 214 has ignored (i.e., not accessed) the digital image file for each of the previous three digital content reports (or some other threshold number), and therefore, the digital image file is not relevant to the second user 214. As shown, the digital space report system 102 determines content relevance indicators such as accesses, comments, shares, modifications, relationships, and inactivity.

In some embodiments, the digital space report system 102 generates a digital team report that indicates digital content items that are relevant to a team of users (rather than to an individual user). In particular, the digital space report system 102 determines content relevance indicators by identifying user activity and/or attributes of digital content items that indicate relevance to a team (i.e., a group of two or more users collaborating on a project within the same digital team space). For example, the digital space report system 102 treats a team as a single entity (e.g, as if it were an individual user) to determine content relevance indicators and resultant relevance scores for digital content items. The digital space report system 102 thus provides a digital space report in the form of a team report that is uniform for each user within the team and that indicates relevant digital content items with respect to the team. In addition, the factors and processes described herein with respect to generating a digital space report for an individual can be applied to generating a digital space report for a team.

Relating to accesses (e.g., clicks or other selections to view, open, or otherwise access the content of a digital content item), the digital space report system 102 determines whether or not a particular user (e.g., the first user 212) has accessed a given digital content item within the flagged collaborative digital team space 216. In addition, the digital space report system 102 determines whether or not other users (e.g., the second user 214) with access to the flagged collaborative digital team space 216 have accessed the digital content item. Further, the digital space report system 102 determines a number and/or a frequency of accesses by the user (e.g., the first user 212) and other users (e.g., the second user 214). In some implementations, the digital space report system 102 determines accesses (including totals and/or frequencies of accesses) over a particular time period, such as a time period since the previous digital space report or a set time period such as a day, a week, or a month.

As mentioned, the digital space report system 102 further determines comments as a content relevance indicator. In particular, the digital space report system 102 determines whether the first user 212 has made comments within or about a particular digital content item. In addition, the digital space report system 102 determines whether other users (e.g., the second user 214) with access the flagged collaborative digital team space 216 have made comments within or about the digital content item. Further, the digital space report system 102 determines a number and/or a frequency of comments by the first user 212 and the second user 214. In some implementations, the digital space report system 102 determines comments (including numbers and/or frequencies of comments) over a particular time period such as a time period since the previous digital space report or a set time period such as a day, a week, or a month (or some other time period).

For determining content relevance indicators (with respect to the first user 212) in the form of shares of a digital content item, the digital space report system 102 determines whether the first user 212 and/or the second user 214 have shared the digital content item with other users. In addition, the digital space report system 102 determines a number and/or frequency of shares by the first user 212 and by the second user 214. Further, the digital space report system 102 determines user information about users with whom the digital content item was shared to determine relationship information with respect to the first user 212. In some implementations, the digital space report system 102 determines shares (including numbers and/or frequencies of shares) over a particular time period such as a time period since the previous digital space report or a set time period such as a day, a week, or a month (or some other time period).

The digital space report system 102 can further determine content relevance indicators in the form of modifications of digital content items. Particularly, the digital space report system 102 determines modifications to digital content items such as additions of newly created digital content items within the flagged collaborative digital team space 216, changes (e.g., additions and/or deletions) to content of an existing digital content item, or deletions of any previously existing digital content items within the flagged collaborative digital team space 216. For example, the digital space report system 102 determines that the video file has been edited by the second user 214. As another example, the digital space report system 102 determines that the first user 212 has added a new file such as the digital image file.

As mentioned, the digital space report system 102 can further determine content relevance indicators based on the user's (or in the form of) relationships. To elaborate, the digital space report system 102 determines relationship information between the first user 212 and other users with access the flagged collaborative digital team space 216 (e.g., the second user 214). For instance, the digital space report system 102 determines that the first user 212 sends and/or receives a threshold number (or a threshold frequency) of digital communicates to or from the second user 214, and the first user 212 and the second user 214 are therefore frequent collaborators. As another example, the digital space report system 102 determines that the first user 212 is a friend or a contact of the second user 214 (or vice versa) and that, therefore, digital content items associated with (e.g., created by, shared by, or commented in by) the second user 214 may be relevant to the first user 212.

In addition, the digital space report system 102 determines relationship information based on organizational structure such as the first user's (and/or the second user's) position or role in a group, a team, or a company (e.g., CEO or engineer). To elaborate, the digital space report system 102 determines that certain digital content items are more relevant than others based on a user's position, title, responsibility, or role. For example, the digital space report system 102 determines that the first user 212 is a team lead who manages the collection of digital content items within the flagged collaborative digital team space 216 and that any newly created digital content items or digital content items with at least a threshold number of modifications are relevant to the first user 212. As another example, the digital space report system 102 determines that the second user 214 is an engineer on the team associated with the flagged collaborative digital team space 216 and that, therefore, certain managerial digital content items (e.g., a meeting agenda) are less relevant than more technical digital content items within the flagged collaborative digital team space 216.

In addition to various user activity, the digital space report system 102 can determine a content relevance indicator based on (or in the form of) user inactivity. To elaborate, the digital space report system 102 determines that failing to, or refraining from, accessing or otherwise interacting with a digital content item indicates disinterest or a lesser degree of relevance. Thus, based on determining that a user does not access or otherwise fails to interact with a particular digital content item, the digital space report system 102 determines that the digital content item is less relevant to the user. For example, the digital space report system 102 provides the text file as part of a threshold number of consecutive digital space reports without identifying any user interaction with the digital content item (or the corresponding content item element) from the first user 212. As another example, the digital space report system 102 determines that the first user 212 does not access the digital content item (e.g., the text file) for at least a threshold period of time to determine that the digital content item is less relevant (or irrelevant) with respect to the first user 212.

In some implementations, the digital space report system 102 determines content relevance indicators by integrating with one or more third-party applications. More specifically, the digital space report system 102 accesses and implements various methods, processes, or functions associated with an application programming interface (“API”) of a third-party application. For instance, the digital space report system 102 integrates with one or more social networking applications and electronic signature applications. Indeed, the digital space report system 102 can access a social graph of a social networking application to determine relationships between users (e.g., the first user 212 and the second user 214) in accordance with nodes and edges of the social graph. In addition, the digital space report system 102 can identify digital content items shared via an electronic signature application that indicate a higher degree of relevance for a user by requesting a signature from the user.

As mentioned above, content relevance indicators can also include attributes of digital content items themselves. More specifically, metadata associated with digital content items indicates various attributes such as which user created the digital content item or added the digital content item to the flagged collaborative digital team space 216. Indeed, a digital content item can include attributes such as a length or a duration of content within the digital content item as well as a subject matter of the content. In addition, a digital content item can be part of a to-do list created by a user. For example, a user can include the digital content item within their own to-do list or a different user (e.g., a manager or a team lead) can create a to-do list instructing the user to perform a task in relation to the digital content item. Based on the various content attributes, the digital space report system 102 determines whether the subject matter, the length/duration, the to-do list (and a relationship with the user that created the to-do list), and/or the creator information indicates a higher or a lower degree of relevance with respect to a particular user.

As further illustrated in FIG. 2, the digital space report system 102 further performs an act 206 to determine relevance scores for the digital content items within the flagged collaborative digital team space 216. In particular, the digital space report system 102 generates relevance scores based on one or more content relevance indicators for each of the digital content items within the flagged collaborative digital team space 216. To determine a relevance score for a digital content item with respect to a particular user (e.g., the first user 212), the digital space report system 102 can represent content relevance indicators numerically, weight content relevance indicators in a fashion specific to the particular user (e.g., the first user 212), and generate a weighted combination of content relevance indicators to generate a relevance score.

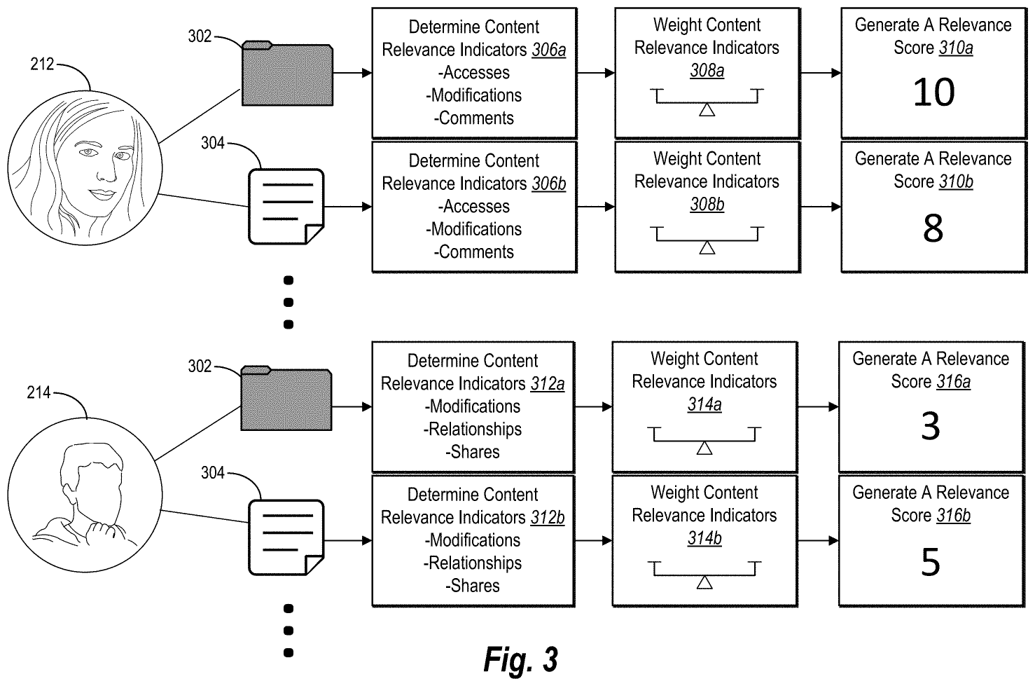

More specifically, the digital space report system 102 weights content relevance indicators based on collaborative digital team space information. Indeed, the digital space report system 102 determines which content relevance indicators are more significant than others in determining relevance of a digital content item with respect to a given user. For example, the digital space report system 102 determines that comments, shares, and/or modifications made by users with weaker relationships with respect the first user 212 (e.g., less frequent collaborators) are weighted less heavily than comments, shares, and/or modifications made by users with stronger relationships (e.g., frequent collaborators). As described, the digital space report system 102 can weight and combine any of the above-mentioned content relevance indicators together to determine a relevance score for a digital content item. Additional detail regarding generating relevance scores for digital content items is provided below with reference to FIG. 3.

As shown in FIG. 2, the digital space report system 102 determines different relevance scores for digital content items with respect to the first user 212 as compared to the relevance scores with respect to the second user 214. Indeed, the digital space report system 102 determines that, of the digital content items within the flagged collaborative digital team space 216, the dark colored folder is most relevant with respect to the first user 212 with a relevance score of 10. The digital space report system 102 further determines a relevance score of 8 for the text file and 7 for the video file with respect to the first user 212.

For comparison, the digital space report system 102 determines that the most relevant digital content item from the flagged collaborative digital team space 216 with respect to the second user 214 is the video file. Indeed, the digital space report system 102 generates a relevance score of 8 for the video file and further generates a relevance score of 7 for the light colored folder and 5 for the text file. While FIG. 2 illustrates relevance scores on a scale from 0 to 10 (or 1 to 10), the digital space report system 102 can generate relevance scores having different formats as well. For instance, in some implementations, the digital space report system 102 generates relevance scores as a percentage or on a scale from 1 to 100.

As illustrated in FIG. 2, the digital space report system 102 further performs an act 208 to generate a digital space report. To elaborate, the digital space report system 102 generates a digital space report that includes relevant digital content items and that excludes (or does not include) irrelevant (or less relevant) digital content items. Indeed, based on the respective relevance scores of content items with respect to the first user 212 and with respect to the second user 214, the digital space report system 102 generates different digital space reports including different content item elements corresponding to relevant (or the most relevant) digital content items for each user.

To generate a digital space report, the digital space report system 102 identifies particular digital content items that satisfy a relevance threshold with respect to a particular user. In addition, the digital space report system 102 determines a threshold number of digital content items to include within a given digital space report. Depending on the various relevance scores and the overall numbers digital content items associated with users, the digital space report system 102 can determine different thresholds (e.g., the relevance threshold and/or the threshold number of digital content items) for different users (e.g., the first user 212 versus the second user 214). For instance, the digital space report system 102 can determine that, because the relevance scores for the digital content items are higher on average for the first user 212 than for the second user 214, the threshold relevance for the first user 212 is higher than that for the second user 214.

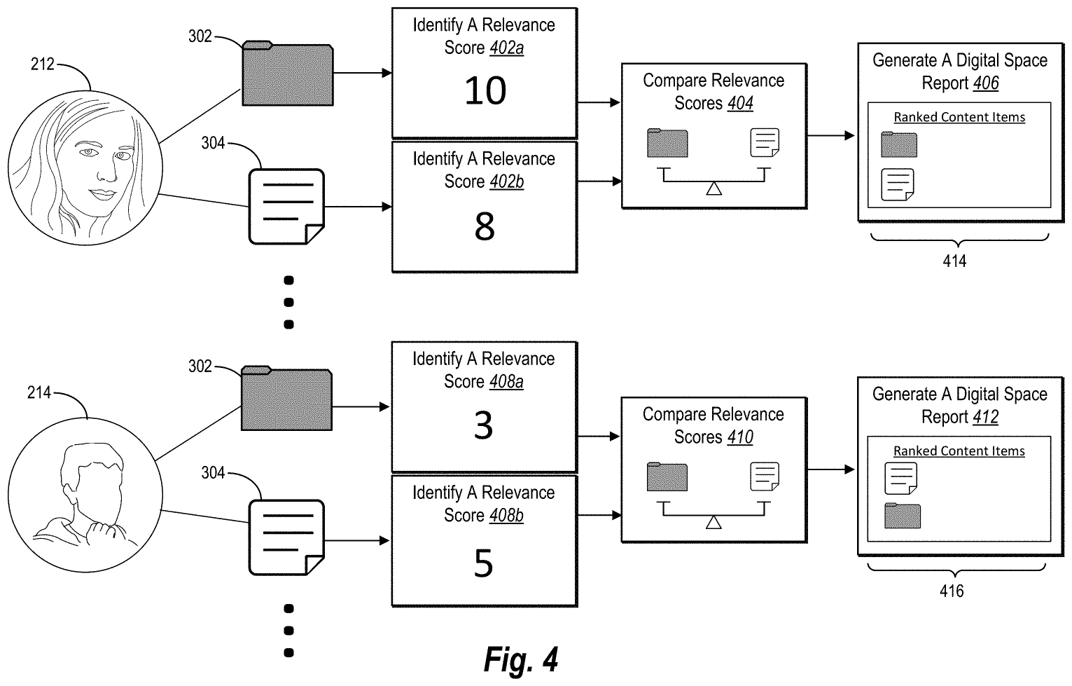

In some implementations, the digital space report system 102 further ranks digital content items according to relevance scores and provides them in ranked order within a digital space report. Indeed, as shown in FIG. 2, the digital space report system 102 generates a digital space report for the first user 212 that includes digital content items in ranked order with the dark colored folder first (with rank 10), the text file second (with rank 8), and the video file third (with rank 7). In some implementations, the digital space report system 102 generates a digital space report to be displayed within a particular interface of the client application 110. In some implementations, instead or in addition to displaying the report within the client application 110, the digital space report system 102 generates a digital space report in the form of an email or other electronic communication to provide to a client device associated with the first user 212 (e.g., the client device 108a). Additional detail regarding generating a digital space report is provided below with reference to FIG. 4.

As shown, the digital space report system 102 additionally performs an act 210 to provide the digital space report for display in a space report interface. More particularly, the digital space report system 102 provides a space report interface for display on a client device associated with the first user 212 (e.g., the client device 108a). The space report interface includes content item elements corresponding to respective relevant digital content items included with the digital space report. Thus, the digital space report system 102 provides an efficient, consolidated view of relevant information within a single user interface that reduces the burden of processing digital communications and reduces numbers of user interactions with the digital communications. Additional detail regarding the space report interface is provided below with reference to subsequent figures.

As further illustrated in FIG. 2, the digital space report system 102 repeats the acts 204-210. In particular, the digital space report system 102 monitors user interaction with content item elements included within the digital space report to access, modify, share, or comment in any of the corresponding digital content items. Based on user interaction with the content item elements and based on the resulting access, modification, share, or comment, the digital space report system 102 determines new content relevance indicators (or updates the content relevance indicators) for the digital content items (e.g., the act 204). In addition, the digital space report system 102 determines new relevance scores (e.g., the act 206) or updates the previously determined relevance scores based on the content relevance indicators. Further, the digital space report system 102 generates a new digital space report (e.g., the act 208) or updates the previous digital image resizing system to provide for display within a space report interface (e.g., the act 210).

In some implementations, the digital space report system 102 continuously repeats the acts 204-210 on a periodic basis. For example, the digital space report system 102 performs the acts 204-210 to generate and provide a new digital space report to the client device 108a of the first user 212 once a week (or on some other time interval). The digital space report system 102 likewise generates digital space reports for other users (e.g., the second user 214) based on their own respective relevance scores.

In one or more implementations, the digital space report system 102 generates and provides a digital space report based on user interaction requesting a digital space report. For example, if the first user 212 returns from a 12-week parental leave and requests a digital space report to catch up on relevant digital content items from that time, the digital space report system 102 generates a digital space report for a user-selected time period (or automatically based on determining that the user was on parental leave). In these or other implementations, the digital space report system 102 generates a digital space report based on identifying relevant digital content items for a period since the previous digital space report.

As mentioned above, the digital space report system 102 can generate relevance scores for digital content items to indicate measures of relevance with respect to a user. In particular, the digital space report system 102 can determine content relevance indicators and can weight the content relevance indicators to generate a relevance score for a particular digital content item. FIG. 3 illustrates generating relevance scores for two different digital content items 302 and 304 in relation to the first user 212 and the second user 214 in accordance with one or more implementations.

As illustrated in FIG. 2, the digital space report system 102 generates different relevance scores for the digital content items 302 and 304. In addition, the digital space report system 102 generates relevance scores in relation to the first user 212 that are different from those in relation to the second user 214, even for the same two digital content item 302 and 304. As indicated by the vertical ellipses in FIG. 3, the digital space report system 102 generates or determines relevance scores for other digital content items as well (e.g., the digital content items within the flagged collaborative digital team space 216).

To generate or determine a relevance score for the digital content item 302 in relation to the first user 212, the digital space report system 102 performs an act 306a to determine (user-specific) content relevance indicators for the digital content item 302. In particular, the digital space report system 102 identifies or determines content relevance indicators for the digital content item 302 that indicate how relevant the digital content item 302 is to the first user 212. In some implementations, the digital space report system 102 identifies only those content relevance indicators that indicate relevance with respect to the first user 212.

For instance, the digital space report system 102 uses a binary determination to identify those content relevance indicators that are associated with the first user 212 and those content relevance indicators that are not associated with the first user 212. For example, the digital space report system 102 determines that modifications have been made to the digital content item 302 (and that modifications are therefore an applicable content relevance indicator), but that no comments have been made within the digital content item 302 (and that comments are therefore not an applicable content relevance indicator).

In one or more implementations, the digital space report system 102 analyzes each of a set of known content relevance indicators (e.g., a set of all possible content relevance indicators) to determine a degree or a measure of relevance for each content relevance indicator with respect to the first user 212. For instance, the digital space report system 102 determines how impactful modifications are to the relevance of the digital content item 302 with respect to the first user 212 as compared to shares or accesses of the digital content item 302.

In some implementations, the digital space report system 102 represents the content relevance indicator numerically for determining an overall relevance score of the digital content item 302 with respect to the first user 212. As shown, the digital space report system 102 identifies content relevance indicators such as accesses, modifications, and comments as (the most) applicable content relevance indicators for the digital content item 302 with respect to the first user 212. In these or other implementations, the digital space report system 102 rates or ranks the content relevance indicators based on their respective impact on relevance with respect to the first user 212.

Indeed, the digital space report system 102 further performs an act 308a to weight the content relevance indicators. In particular, the digital space report system 102 weights the content relevance indicators based on collaborative digital team space information. To elaborate, the digital space report system 102 determines how much to weight the content relevance indicators based on their respective impact on relevance with respect to the first user 212 as indicated by collaborative digital team space information. For example, the digital space report system 102 determines collaborative digital team space information such as an amount of time (or a number of interactions) the first user 212 spends interacting with the digital content item 302 to indicate an impact on relevance of any modifications or comments to the digital content item 302. As another example, digital space report system 102 determines a number of communications between the first user 212 and a creator (or a commenter or a modifier) of the digital content item 302 to thus indicate a strength of a relationship.

Indeed, the digital space report system 102 determines an impact on the relevance of various content relevance indicators based on collaborative digital team space information within the flagged collaborative digital team space 216. Such collaborative digital team space information includes user activity and relationship information that indicates how much a given content relevance indicator may affect the overall relevance with respect to the first user 212. For example, in some implementations, the digital space report system 102 weights more frequent (or more numerous) user activity with the digital content item 302 (e.g., accesses, modifications, comments, or shares) more heavily than less frequent (or less numerous) activity. In some cases, the digital space report system 102 weights more recent user activity more heavily than less recent user activity. In addition, the digital space report system 102 weights relationships with more frequent (or more numerous) interactions more heavily than relationships with less frequent (or less numerous) interactions. In some cases, the digital space report system 102 weights relationships with more recent interactions more heavily than relationships with less recent interactions.

As shown, the digital space report system 102 further performs an act 310a to generate a relevance score for the digital content item 302 in relation to the first user 212. More specifically, the digital space report system 102 combines the weighted content relevance indicators to generate a relevance score. Indeed, the digital space report system 102 generates a weighted combination (e.g., a weighted linear combination or a weighted nonlinear combination) of two or more content relevance indicators. For example, the digital space report system 102 generates a relevance score based on a number of modifications made to the digital content item 302, relationships between the first user 212 and the users who made the modifications, and a recency associated with each of the modifications. As another example, the digital space report system 102 generates a relevance score based on identifying the digital content item 302 within a to-do list associated with the first user 212, a relationship of the first user 212 with the creator of the to-do list, and a recency of the to-do list.

In some implementations, the digital space report system 102 weights inactivity of the first user 212 more heavily based on activity of other users with access to the flagged collaborative digital team space 216. For instance, the digital space report system 102 determines that the digital content item 302 has at least a threshold number (or a threshold frequency) of accesses by other users with access to the flagged collaborative digital team space 216. Based on this determination, the digital space report system 102 further weights inactivity (e.g., a non-access) of the first user 212 more heavily to indicate a higher degree of relevance to the first user 212 (to indicate to the first user 212.

As mentioned above, the digital space report system 102 generates relevance scores to indicate digital content items that are newly added to the flagged collaborative digital team space 216 (i.e., added in the time since the previous digital space report was sent), that are newly modified (modified since the previous digital space report), and/or that have new comments (comments added since the previous digital space report). In addition, the digital space report system 102 determines relevance scores to indicate digital content items that have at least a threshold number of accesses by other users but that the first user 212 did not access. The digital space report system 102 also uses relevance scores to identify digital content items that are shared with the first user 212 but that first user 212 did not access. In addition, the digital space report system 102 uses relevance scores to identify digital content items that the first user 212 shares but that were no accessed by other users with access to the flagged collaborative digital team space 216.

As illustrated in FIG. 3, the digital space report system 102 further generates a relevance score for the digital content item 304 in relation to the first user 212. Similar to the discussion above relating to the digital content item 302, the digital space report system 102 performs the acts 306a, 308b, and 310b to determine content relevance indicators, weight the content relevance indicators, and generate a relevance score based on the weighted content relevance indicators. As shown, the digital space report system 102 generates a relevance score of 10 for the digital content item 302 and a relevance score of 8 for the digital content item 304. In a similar fashion, the digital space report system 102 generates relevance scores for other digital content items within the flagged collaborative digital team space 216.

As further illustrated in FIG. 3, the digital space report system 102 generates relevance scores for the digital content item 302 and the digital content item 304 in relation to the second user 214. In particular, the digital space report system 102 performs the acts 312a, 314a, and 316 to determine a relevance score for the digital content item 302 in accordance with the above description in relation to the first user 212. In addition, the digital space report system 102 performs the acts 312b, 314b, and 316b to determine a relevance score for the digital content item 304 in relation to the second user 214. As shown, the digital space report system 102 determines a relevance score of 3 for the digital content item 302 and a relevance score of 5 for the digital content item 304 in relation to the second user 214.

As mentioned above, the digital space report system 102 can generate a digital space report for a user based on relevance scores of digital content items. In particular, the digital space report system 102 can compare relevance scores of digital content items to rank the digital content items according to relevance scores. The digital space report system 102 can further generate a digital space report to include the digital content items in ranked order. FIG. 4 illustrates generating a digital space report for the first user 214 and generating a different digital space report for the second user 214 in accordance with one or more implementations.

As illustrated in FIG. 4, the digital space report system 102 performs an act 402a to identify a relevance score associated with the digital content item 302. In addition, the digital space report system 102 performs an act 402b to identify a relevance score associated with the digital content item 304. Indeed, the digital space report system 102 identifies the relevance scores determined as described above.

Based on identifying the relevance scores, the digital space report system 102 performs an act 404 to compare the relevance scores. In particular, the digital space report system 102 compares the relevance score of the digital content item 302 (10) with the relevance score of the digital content item 304 (8). Based on the comparison, the digital space report system 102 further ranks the digital content items. Indeed, the digital space report system 102 ranks the digital content item 302 above the digital content item 304 because it has a higher relevance score with respect to the first user 212.

As shown, the digital space report system 102 further generates a digital space report to include the ranked digital content items. In particular, the digital space report system 102 generates a digital space report 414 that includes content item elements for the respective digital content items. Indeed, as shown in FIG. 4, the digital space report 414 includes a content item element for the digital content item 302 and a content item element for the digital content item 304. As shown, the digital space report 414 includes the content item element for the digital content item 302 above that for the digital content item 304 because the relevance score for the digital content item 302 is the higher of the two. In some embodiments, however, the digital space report system 102 provides the digital space report 414 with content item elements in a different order, such as a chronological order (e.g., by creation date, by modified date, or by accessed date) or a category-based order (e.g., where content item elements corresponding to digital content items of like types are grouped together). The digital space report system 102 further provides the digital space report for display within a space report interface on the client device 108a associated with the first user 212.

As further illustrated in FIG. 4, the digital space report system 102 generates a digital space report 416 for the second user 214. In particular, the digital space report system 102 performs the act 408a to identify a relevance score for the digital content item 302. In addition, the digital space report system 102 performs an act 408b to identify a relevance score for the digital content item 304 in relation to the second user 214. In addition, the digital space report system 120 performs an act 410 to compare the relevance scores of the digital content item 302 and the digital content item 304. Indeed, the digital space report system 102 ranks the digital content items based on their respective relevance scores.

Based on the comparison, the digital space report system 102 further performs an act 412 to generate a digital space report 416 for the second user 214. Indeed, the digital space report system 102 generates the digital space report 416 to include a content item element for the digital content item 304 above the content item element for the digital content item 302 because the digital content item 304 has a higher relevance score in relation to the second user 214. The digital space report 102 further provides the digital space report 416 for display on a client device 108b associated with the second user 214.

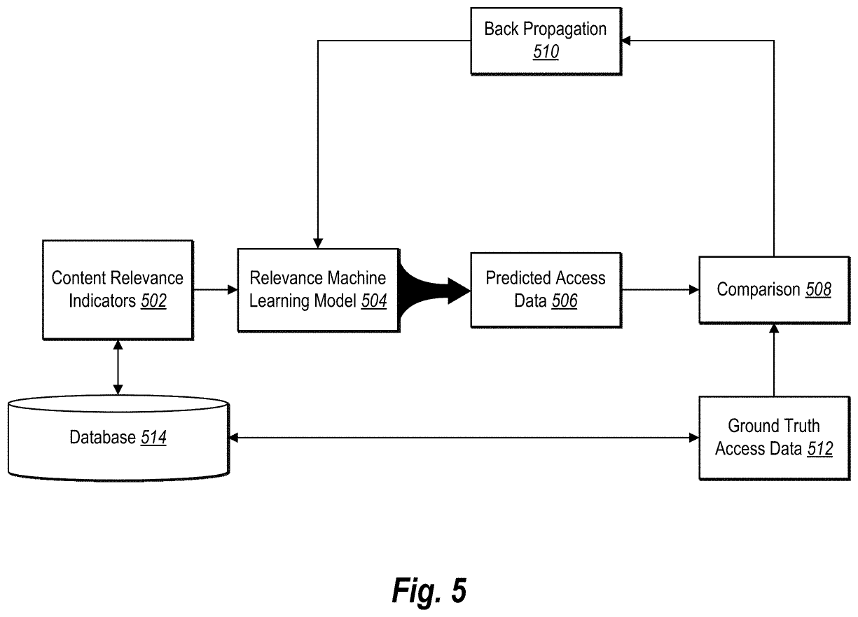

As mentioned, the digital space report system 102 can utilize a machine learning model to determine relevance of digital content item with respect to a user. In particular, the digital space report system 102 can train a machine learning model to determine or predict whether a user will access a particular digital content item given the content relevance indicators associated with the digital content item. FIG. 5 illustrates training a relevance machine learning model 504 in accordance with one or more implementations.

As show in FIG. 5, the digital space report system 102 accesses content relevance indicators 502 for a digital content item from a database 514. In addition, the digital space report system 102 accesses corresponding ground truth access data 512 for the digital content item. The ground truth access data 512 indicates whether or not the user (or a similar user) accessed the digital content item associated with the content relevance indicators 502. In some implementations (e.g., implementations where the relevance machine learning model 504 is a probability determination neural network rather than a binary classification neural network), the ground truth access data 512 indicates a ground truth relevance score (represented as a probability of the user accessing the digital content item) for a digital content item associated with the content relevance indicators 502.

In addition, the digital space report system 102 inputs the content relevance indicators 502 into the relevance machine learning model 504 (e.g., a binary classification neural network) or a probability determination neural network). The relevance machine learning model 504 analyzes the content relevance indicators 502 to generate and pass latent features and other data between various neurons and layers to ultimately generate predicted access data 506. Indeed, the relevance machine learning model 504 generates the predicted access data 506 based on the content relevance indicators 502. The predicted access data 506 includes a prediction of a binary classification (e.g., access or not access) to indicate whether or not a user will access the digital content item associated with the content relevance indicators 502. In some implementations, the predicted access data 506 is not a binary classification but is rather a probability of whether or not the user will access the digital content item associated with the content relevance indicator.

To determine a measure of loss or error associated with the relevance machine learning model 504, the digital space report system 102 further performs a comparison 508. Particularly, the digital space report system 102 compares the predicted access data 506 with the ground truth access data 512. For example, the digital space report system 102 performs the comparison 508 by implementing a loss function such as a cross entropy loss function or a mean square error loss function. In any event, the digital space report system 102 utilizes a loss function to determine an error or a measure of loss associated with the relevance machine learning model 504 by comparing the predicted access data 506 with the ground truth access data 512.

As further illustrated in FIG. 5, the digital space report system 102 performs a back propagation 510. In particular, the digital space report system 102 back propagates to adjust or modify various internal parameters of the relevance machine learning model 504. For example, the digital space report system 102 modifies weights, relationships, and other parameters to change the way the neurons and layers generate and pass information, thereby altering how the relevance machine learning model 504 determines features from an input and ultimately generates an output. Thus, the digital space report system 102 attempts to minimize or reduce the measure of loss or error associated with the relevance machine learning model 504 by modifying the internal parameters to subsequently generate more accurate predictions.

Upon back propagating to modify various parameters, the digital space report system 102 further repeats the training process illustrated in FIG. 5. Indeed, the digital space report system 102 repeats the training for a particular number of iterations or epochs and/or until the relevance machine learning model 504 satisfies a threshold measure of loss (or until the predicted access data 506 is within a threshold similarity of the ground truth access data 512).

For example, the digital space report system 102 identifies new content relevance indicators from the database 514 and corresponding new ground truth access data. The digital space report system 102 further inputs the new content relevance indicators into the relevance machine learning model 504 to generate new predicted access data 506. Further, the digital space report system 102 compares the new predicted access data with the new ground truth access data utilizing a loss function. Additionally, the digital space report system 102 back propagates to further modify weights and parameters of the relevance machine learning model 504 to reduce the loss. By repeating the training process, the digital space report system 102 improves the accuracy of the relevance machine learning model 504 to generate accurate predicted access data based on content relevance indicators of a digital content item.

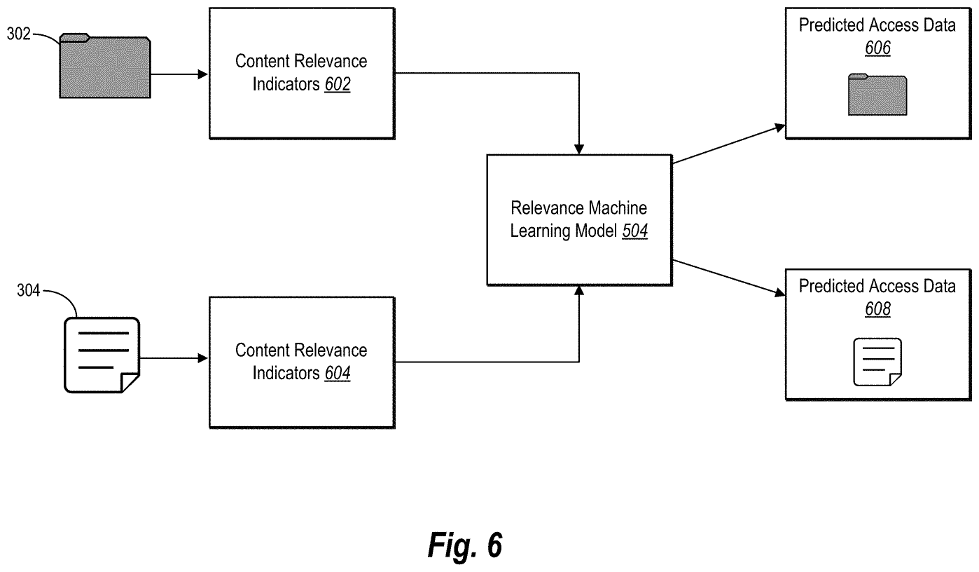

As mentioned, the digital space report system 102 can apply a trained relevance machine learning model (e.g., the relevance machine learning model 504) to determine predicted access data for a particular digital content item. FIG. 6 illustrates applying the trained relevance machine learning model 504 to generate predicted access data 606 for the digital content item 302 and to generate predicted access data 608 for the digital content item 304 in accordance with one or more implementations.

As illustrated in FIG. 6, the digital space report system 102 identifies the content relevance indicators 602 for the digital content item 302. In addition, the digital space report system 102 inputs the content relevance indicators 602 into the relevance machine learning model 504. The relevance machine learning model 504, in turn, generates the predicted access data 606 corresponding to the digital content item 302. Indeed, the relevance machine learning model 504 generates a prediction of whether or not a given user (e.g., the first user 212) will access the digital content item 302 based on the content relevance indicators 602 (e.g., as a classification of access or not access). In some implementations, the relevance machine learning model 504 generates the predicted access data 606 in the form of a probability of the user accessing the digital content item 302 based on the content relevance indicators 602. In these implementations, the probability can indicate a relevance score for the digital content item 302.

In a similar fashion, the digital space report system 102 applies the relevance machine learning model 504 to generate the predicted access data 608 for the digital content item 304. In particular, the digital space report system 102 inputs the content relevance indicators 604 associated with the digital content item 304 into the relevance machine learning model 504. The relevance machine learning model 504, in turn, generates the predicted access data 608 either in the form of: 1) an indication that the user will access or will not access the digital content item 304 based on the content relevance indicators 604, or 2) a probability of the user accessing the digital content item 304 based on the content relevance indicators 604.

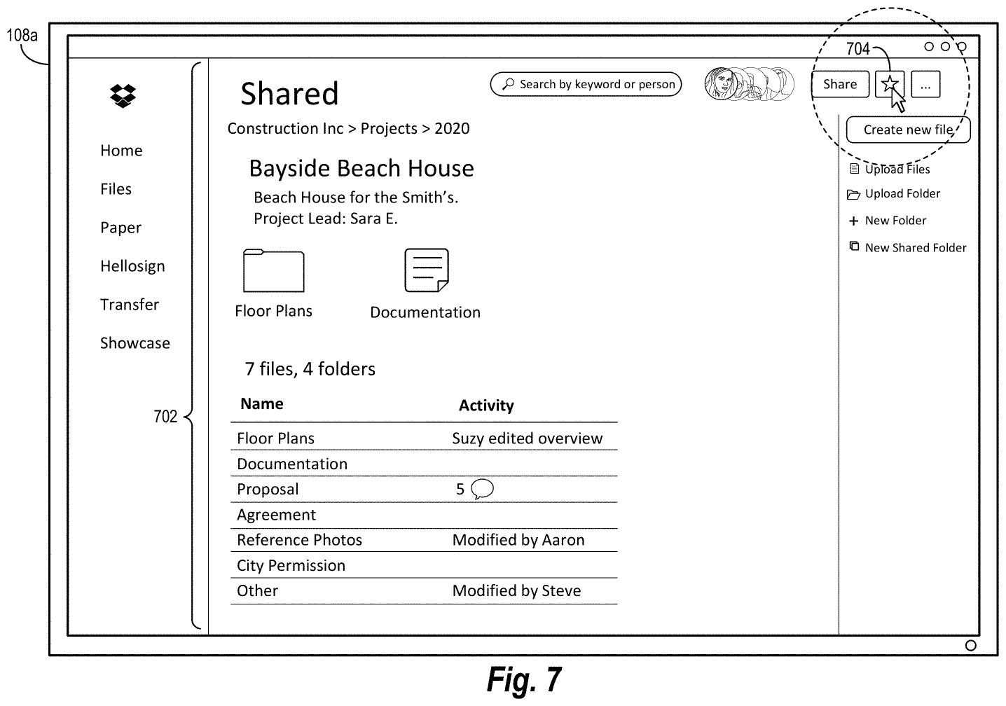

As mentioned above, the digital space report system 102 can identify a flagged collaborative digital team space for a user. In particular, the digital space report system 102 can receive or identify a user interaction selecting, starring, or otherwise flagging a collaborative digital team space to indicate that the collaborative digital team space is significant or of interest to the user. FIG. 7 illustrates the client device 108a displaying a space report interface 702 for a collaborative digital team space and indicating a user interaction to flag the collaborative digital team space. While FIG. 7 illustrates the client device 108a in the form of a desktop or a laptop device, the client device 108a can also be a mobile device, and the digital space report system 102 can provide the digital space report for display in a mobile format.

As illustrated in FIG. 7, the space report interface 702 includes content item elements for digital content items associated with a user (e.g., the first user 212) and other users with access to the collaborative digital team space. As further illustrated in FIG. 7, the space report interface 702 includes a flag element 704 selectable to flag the collaborative digital team space associated with the space report interface 702 in accordance with one or more implementations.

Indeed, the digital space report system 102 receives or identifies a user interaction selecting the flag element 704 within the space report interface 702. Based on the user interaction, the digital space report system 102 determines that the collaborative digital team space is a flagged collaborative digital team space for providing content item updates to the user.

In some implementations, the digital space report system 102 automatically (e.g., without user input) flags the collaborative digital team space for the user based on user activity within the collaborative digital team space. For example, the digital space report system 102 flags the collaborative digital team space for the user based on determining that the user spends at least a threshold amount of time within the space report interface 702. As another example, the digital space report system 102 flags the collaborative digital team space for the user based on determining that the user access the space report interface 702 at least a threshold number of times (or with at least a threshold frequency). As yet another example, the digital space report system 120 flags the digital space report system for the user based on determining that the user performs at least a threshold number of user interactions with one or more digital content items within the collaborative digital team space.

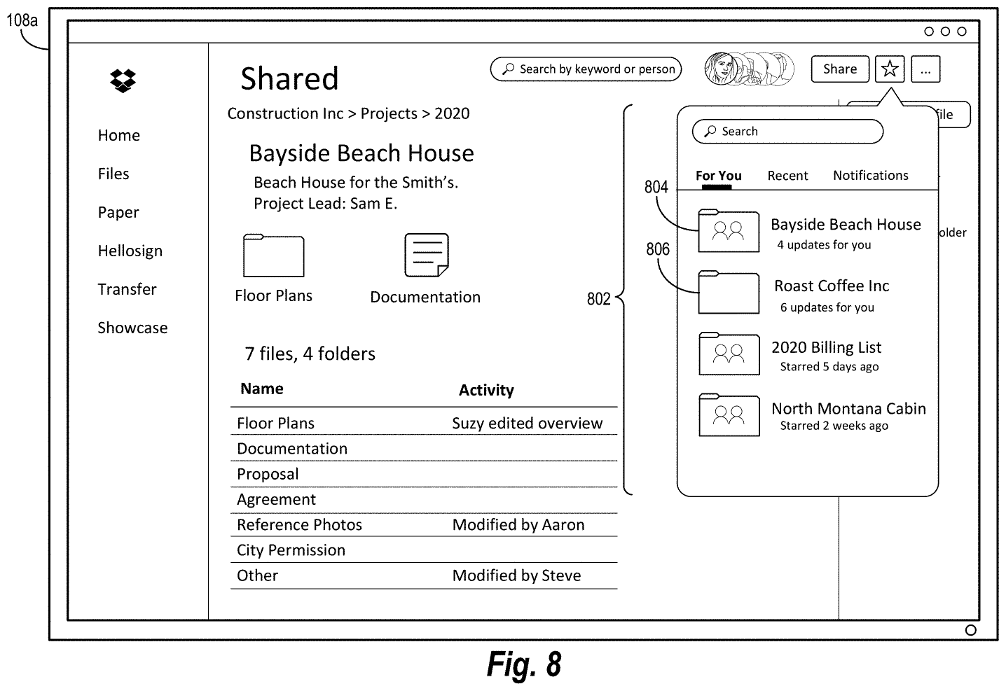

As mentioned, the digital space report system 102 can provide a multi-space report summary interface to summarize content updates associated with multiple flagged collaborative digital team spaces. In particular, the digital space report system 102 can identify one or more flagged collaborative digital team spaces for a user and can provide a multi-space report summary interface for display on a client device to summarize content updates within the one or more flagged collaborative digital team spaces. FIG. 8 illustrates the client device 108a displaying a multi-space report summary interface 802 in accordance with one or more implementations.

As illustrated in FIG. 8, the multi-space report summary interface 802 includes a team space element 804 corresponding to the “Bayside Beach House” flagged collaborative digital team space as well as a team space element 806 corresponding to the “Roast Coffee Inc” flagged collaborative digital team space. The multi-space report summary interface 802 includes additional team space elements for the “2020 Billing List” flagged collaborative digital team space and the “North Montana Cabin” flagged collaborative digital team space as well. The team space element 804 is selectable to navigate to a space report interface associated with the “Bayside Beach House” collaborative digital team space. Similarly, the team space element 806 is selectable to navigate to a space report interface associated with the “Roast Coffee Inc” collaborative digital team space. By providing the multi-space report summary interface 802, the digital space report system 102 efficiently (e.g., within a single, consolidated interface) summarizes updates that have occurred in relation to digital content items within the respective flagged collaborative digital team spaces.

Indeed, as shown in FIG. 8, the multi-space report summary interface 802 includes update summaries for each of the flagged collaborative digital team spaces. In some implementations, the update summaries indicate numbers of relevant digital content items (or numbers of updates associated with the relevant digital content items) within the respective flagged collaborative digital team spaces. For example, the multi-space report summary interface 802 includes an update summary of “4 updates for you” for the “Bayside Beach House” collaborative digital team space. In addition, the multi-space report summary interface 802 includes an update summary of “6 updates for you” for the “Roast Coffee Inc” collaborative digital team space. Likewise, the other collaborative digital team spaces of the multi-space report summary interface 802 includes update summaries of “Starred 5 days ago” and “Starred 2 weeks ago” indicating how long ago the collaborative digital team spaces were flagged.

In some implementations, the digital space report system 102 provides a multi-space report summary interface in a different format. For example, the multi-space report summary interface 802 generates and provides an email with a multi-space report summary included within. In these implementations, the multi-digital space report system 102 provides the multi-space report summary interface as part of the email (e.g., so that the user can view the multi-space report summary interface upon opening the email).

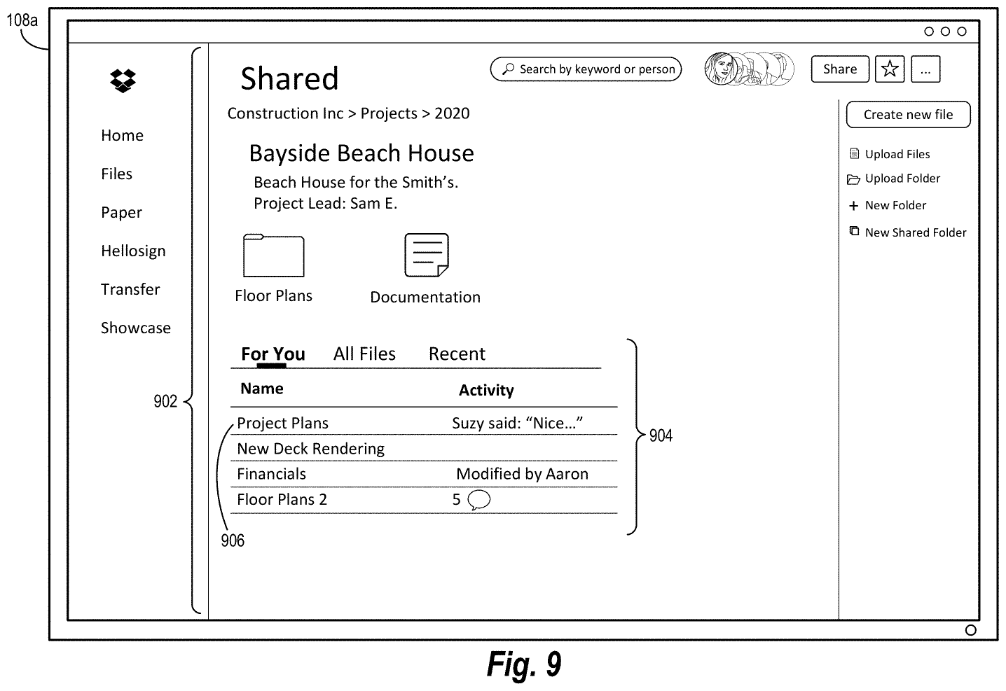

As mentioned, the digital space report system 102 can provide a space report interface in response to user interaction selecting a team space element (e.g., from within the multi-space report summary interface 802). FIG. 9 illustrates a space report interface 902 that the digital space report system 102 provides for display in response to user interaction selecting the team space element 804 in accordance with one or more implementations.

As illustrated in FIG. 9, the client device 108a displays the space report interface 902 including a digital space report 904. Within the digital space report 904, the space report interface 902 displays content item elements (e.g., links) selectable to navigate to respective digital content items. For example, the digital space report 904 includes a content item element 906 selectable to navigate to the “Project Plans” digital content item. Similarly, the digital space report 904 includes content item elements for other digital content items such as the “New Deck Rendering” digital content item, the “Financials” digital content item, and the “Floor Plans 2” digital content item.

In addition to the content item elements, the digital space report 904 includes relevance markers that explain why the digital content items are relevant to the user. In particular, the digital space report system 102 generates the relevance markers from the content relevance indicators associated with the various digital content items. For example, the digital space report 904 indicates that the “Project Plans” digital content item has a relevance marker of “Suzy said: ‘Nice . . . ’.” In addition, the “Financials” digital content item has a corresponding relevance marker of “Modified by Aaron.” Similarly, the “Floor Plans 2” digital content item has a relevance marker indicating that five comments have been made in relation to the digital content item (since the user last accessed the digital content item).

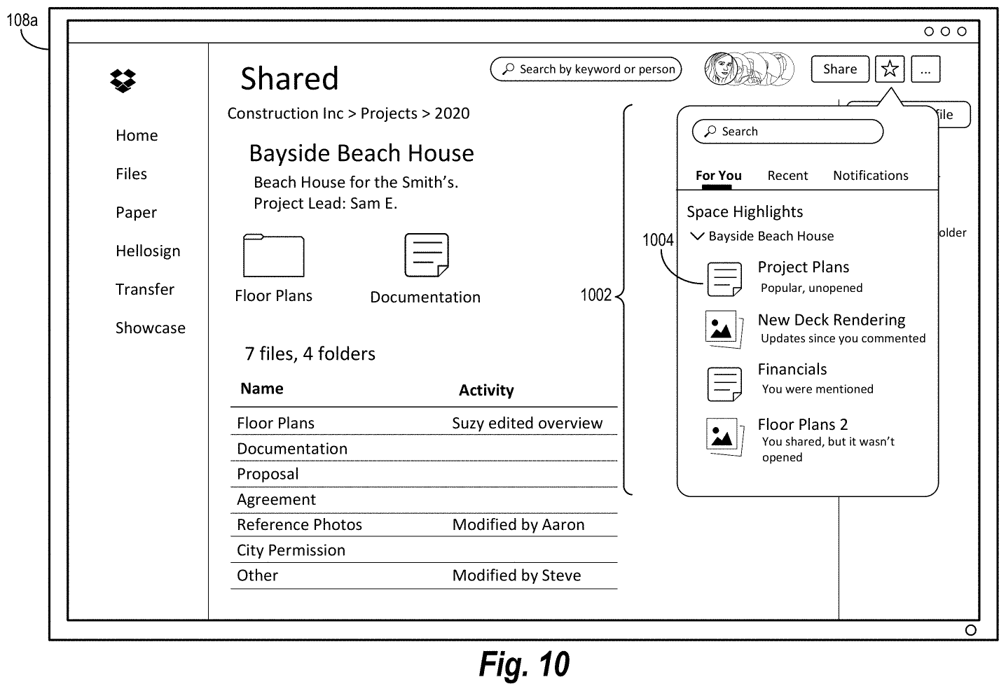

As shown in FIG. 9, the digital space report system 102 provides the digital space report 904 within a particular format—i.e., within a “For You” tab of the client application 110. In some implementations, the digital space report system 102 provides a digital space report in a different format. For example, FIG. 10 illustrates a space report interface 1002 within a nested window of the client application 110 in accordance with one or more implementations.

As illustrated in FIG. 10, the digital space report system 102 provides the space report interface 1002 for display on the client device 108a within a nested window. In particular, the digital space report system 102 (or the client application 110) displays the space report interface 1002 in response to user interaction to select or hover over the star element. The space report interface 1002 includes content item elements selectable to access respective digital content items. For example, the space report interface 1002 includes a content item element 1004 selectable to access the “Project Plans” digital content item. The space report interface 1002 also includes content item elements corresponding to the “New Deck Rendering” digital content item, the “Financials” digital content item, and the “Floor Plans 2” digital content item.

In addition to the content item elements, the space report interface 1002 also includes relevance markers. For example, the space report interface 1002 includes a relevance marker of “Popular, unopened” to indicate to the user that the “Project Plans” digital content item has been accessed by other users but not by the user of the client device 108a (e.g., the first user 212). In addition, the space report interface 1002 includes a relevance marker of “Updates since you commented” for the “New Deck Rendering” digital content item, to indicate to the user that other users have modified the digital content item since the user last commented on it. Further, the space report interface 1002 includes a relevance marker of “You were mentioned” for the “Financials” digital content item to indicate that the user was mentioned either in the digital content item or in a comment associated with the digital content item. Further still, the space report interface 1002 includes a relevance marker of “You shared, but it wasn't opened” to indicate that the user shared the “Floor Plans 2” digital content item, but none of the other users with access to the flagged collaborative digital team space accessed it.

In some implementations, the digital space report system 102 provides the space report interface 1002 in response to user interaction with the star element. For example, upon determining that the user has flagged only a single collaborative digital team space, the digital space report system 102 utilizes the nested window to display the space report interface 1002. However, upon determining that the user has flagged multiple collaborative digital team spaces, the digital space report system 102 utilizes the nested window to display a multi-space report summary interface such as the multi-space report summary interface 802 described above in relation to FIG. 8.

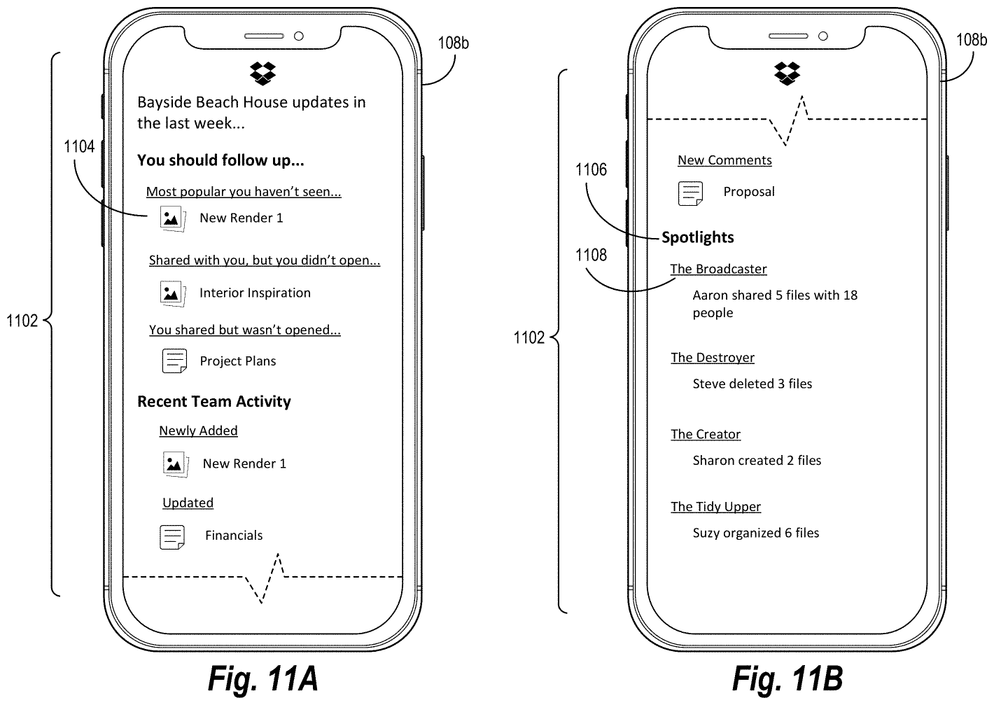

As mentioned above, the digital space report system 102 can provide a digital space report in different formats. For example, the digital space report system 102 can generate and provide a digital space report in the form of an email. In addition, the digital space report system 102 can generate and provide a digital space report in mobile format, desktop format, browser format, or some other format compatible with a client device and a client application. Indeed, the digital space report system 102 can provide the above-described interfaces and digital space reports for display on various types of client devices as described herein. FIGS. 11A-11B illustrate a client device 108b (e.g., a mobile device) displaying a space report interface 1102 for an email including a digital space report in accordance with one or more implementations.

As illustrated in FIG. 11A, the client device 108b displays the space report interface 1102 as an email including various content item elements and corresponding relevance markers. For example, the space report interface 1102 includes a content item element 1104 for the “New Render 1” digital content item, along with the relevance marker of “Most popular you haven't seen.” The relevance marker indicates to the user that, of the digital content items with the collaborative digital team space that the user has not seen, the “New Render 1” digital content item has the most accesses by other users.

In addition, the space report interface 1102 includes relevance markers for other digital content items as well. Such relevance markers include “Shared with you, but you didn't open” to indicate a digital content item that another user shared with the user, but that the user did not access. Other relevance markers include “You shared but wasn't opened,” “Newly Added,” “Updated,” and “New Comments” to indicate, explain, or summarize one or more content relevance indicators associated with the respective digital content items.

Continuing the space report interface 1102 to FIG. 11B, the space report interface 1102 includes a spotlight section 1106. Within the spotlight section 1106, the space report interface 1102 further includes one or more spotlight elements corresponding to users who have accomplished particular achievements. To elaborate, the digital space report system 102 monitors user activity within the flagged collaborative digital team space corresponding to the digital space report of the space report interface 1102. Based on the user activity, the digital space report system 102 determines users who achieve particular accomplishments within the flagged collaborative digital team space for a particular time period (e.g., since the previous digital space report). Example accomplishments include sharing the most (or fewest) digital content items, deleting or removing the most (or fewest) digital content items, accomplishing the most (or fewest) items on a to-do list, creating the most (or fewest) digital content items, organizing the most (or fewest) digital content items, adding the most (or fewest) comments within digital content items, and/or making the most (or fewest) modifications to digital content items.

As illustrated in FIG. 11B, the space report interface 1102 includes a spotlight element 1108 of “The Broadcaster” to indicate that Aaron has shared 5 files with 18 people (since the previous digital space report). In addition, the space report interface 1102 includes a spotlight element of “The Destroyer” to indicate that Steve deleted 3 files (since the previous digital space report). Further, the space report interface 1102 includes a spotlight element of “The Creator” to indicate that Sharon created 2 files (since the previous digital space report). Further, the space report interface 1102 includes a spotlight element of “The Tidy Upper” to indicate that Suzy organized 6 files (since the previous digital space report).

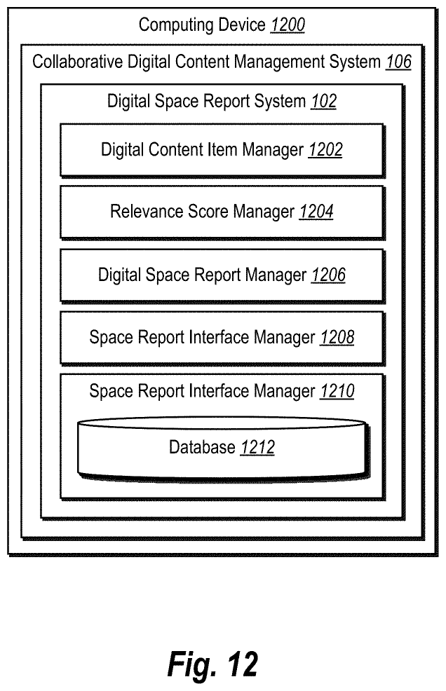

Looking now to FIG. 12, additional detail will be provided regarding components and capabilities of the digital space report system 102. Specifically, FIG. 12 illustrates an example schematic diagram of the digital space report system 102 on an example computing device 1200 (e.g., one or more of the client devices 108a-108n and/or the server(s) 104). As shown in FIG. 12, the digital space report system 102 may include a digital content item manager 1202, a relevance score manager 1204, a digital space report manager 1206, a space report interface manager 1208, and a storage manager 1210. The storage manager 1210 can operate in conjunction with one or more memory devices (e.g., the database 1212) that store various data such as a machine learning architecture, digital content items, user accounts, digital space reports, and collaborative digital team spaces.

As just mentioned, the digital space report system 102 includes a digital content item manager 1202. In particular, the digital content item manager 1202 manages, maintains, stores, identifies, provides, transfers, moves, removes, deletes, modifies, or updates digital content items within various collaborative digital team spaces. For example, the digital content item manager 1202 identifies user interaction to access a digital content item from a particular collaborative digital team space, and the digital content item manager 1202 provides access to the digital content item. As another example, the digital content item manager 1202 identifies a modification made to a digital content item with in a collaborative digital team space, and the digital content item manager 1202 stores the modified digital content item within the collaborative digital team space.

In addition, the digital space report system 102 includes a relevance score manager 1204. In particular, the relevance score manager 1204 manages, maintains, determines, generates, or identifies relevance scores for digital content items with respect to users. For example, the relevance score manager 1204 identifies user activity and digital content item information to determine a relevance score of the digital content item with respect to a given user, as described above. Indeed, the relevance score manager 1204 determines content relevance indicators for digital content items and weights the content relevance indicator for determining a relevance score.

As shown, the digital space report system 102 also includes a digital space report manager 1206. In particular, the digital space report manager 1206 manages, maintains, determines, generates, provides, displays, presents, or identifies a digital space report. For example, the digital space report manager 1206 generates a digital space report based on relevance scores of digital content items with respect to a user. Indeed, the digital space report manager 1206 generates a user-specific digital space report that indicates digital content items from a flagged collaborative digital team space that are relevant to a user and that includes content item elements selectable to access the digital content items.

Further, the digital space report system 102 includes a space report interface manager 1208. In particular, the space report interface manager 1208 displays, presents, portrays, or provides a space report interface of a digital space report. For example, the space report interface manager 1208 displays a space report interface for a particular digital space report that includes content item elements for a given flagged collaborative digital team space.

In one or more implementations, each of the components of the digital space report system 102 are in communication with one another using any suitable communication technologies. Additionally, the components of the digital space report system 102 can be in communication with one or more other devices including one or more client devices described above. It will be recognized that although the components of the digital space report system 102 are shown to be separate in FIG. 12, any of the subcomponents may be combined into fewer components, such as into a single component, or divided into more components as may serve a particular implementation. Furthermore, although the components of FIG. 12 are described in connection with the digital space report system 102, at least some of the components for performing operations in conjunction with the digital space report system 102 described herein may be implemented on other devices within the environment.

The components of the digital space report system 102 can include software, hardware, or both. For example, the components of the digital space report system 102 can include one or more instructions stored on a computer-readable storage medium and executable by processors of one or more computing devices (e.g., the computing device 1200). When executed by the one or more processors, the computer-executable instructions of the digital space report system 102 can cause the computing device 1200 to perform the methods described herein. Alternatively, the components of the digital space report system 102 can comprise hardware, such as a special purpose processing device to perform a certain function or group of functions. Additionally or alternatively, the components of the digital space report system 102 can include a combination of computer-executable instructions and hardware.

Furthermore, the components of the digital space report system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the digital space report system 102 may be implemented as part of a stand-alone application on a personal computing device or a mobile device.

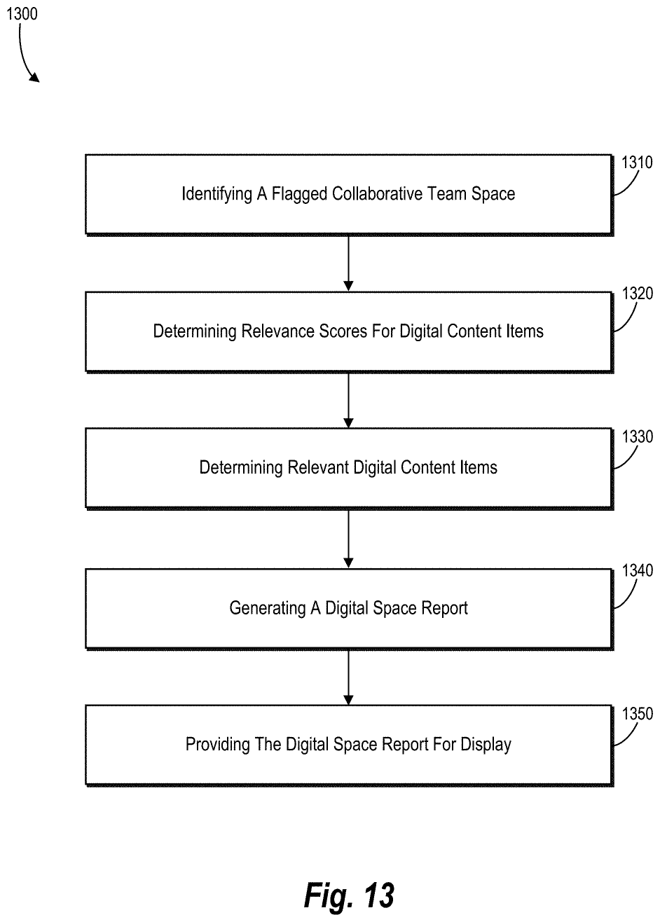

FIGS. 1-12, the corresponding text, and the examples provide a number of different systems and methods for generating and providing a digital space report for a flagged collaborative digital team space. In addition to the foregoing, implementations can also be described in terms of flowcharts comprising acts steps in a method for accomplishing a particular result. For example, FIG. 13 illustrates a series of acts 1300 for generating and providing a digital space report for a flagged collaborative digital team space.

While FIG. 13 illustrates acts according to one implementation, alternative implementations may omit, add to, reorder, and/or modify any of the acts shown in FIG. 13. The acts of FIG. 13 can be performed as part of a method. Alternatively, a non-transitory computer readable medium can comprise instructions, that when executed by one or more processors, cause a computing device to perform the acts of FIG. 13. In still further implementations, a system can perform the acts of FIG. 13.

As illustrated in FIG. 13, series of acts 1300 may include act 1310 of identifying a flagged collaborative digital team space. In particular, the act 1310 can involve identifying, from a plurality of collaborative digital team spaces including respective collections of digital content items accessible by a client device associated with a user, a flagged collaborative digital team space selected for receiving digital content item updates.

As shown, the series of acts 1300 includes an act 1320 of determining relevance scores for digital content items. Relevance scores can include weighted combinations of a plurality of content relevance indicators for digital content items within the collection of digital content items with respect to the user. In particular, the act 1320 can involve, in response to identifying the flagged collaborative digital team space, determining, based on a plurality of content relevance indicators relative to the user associated with the client device, relevance scores with respect to the user for digital content items within the flagged collaborative digital team space. For example, the act 1320 can involve identifying the plurality of content relevance indicators indicating measures of relevance of digital content items with respect to the user and weighting the plurality of content relevance indicators for the digital content items based on collaborative digital team space information associated with the user. Indeed, determining weighted combinations of the plurality of the content relevance indicators can include weighting, for each digital content item within the flagged collaborative digital team space, the plurality of content relevance indicators based on collaborative digital team space information associated with the user and combining the weighted plurality of content relevance indicators for each digital content item within the collection of digital content items.

Determining the collaborative digital team space information can include one or more of monitoring user activity within the flagged collaborative digital team space or determining relationship information between the user and other users with access to the flagged collaborative digital team space. Determining content relevance indicator can include determining two or more of: a frequency of access of a digital content item by the user, a frequency of access of the digital content item by other users with access to the flagged collaborative digital team space, a number of accesses of the digital content item by the user, a number of accesses of the digital content item by other users with access to the flagged collaborative digital team space, a relationship of the user with another user with access to the flagged collaborative digital team space, a number of shares of the digital content item, a number of comments made within the digital content item, or a number of modifications made to the digital content item.

In addition, the series of acts 1300 includes an act 1330 of determining relevant digital content items. In particular, the act 1330 can involve determining one or more relevant digital content items from the digital content items within the flagged collaborative digital team space based on the relevance scores of the one or more relevant digital content items satisfying a relevance threshold with respect to the user. The act 1330 can involve identifying one or more of: a digital content item that has been shared with the user by another user with access to the flagged collaborative digital team space and that the user has not yet accessed, a digital content item that the user has shared with another user with access to the flagged collaborative digital team space and that the another user has not yet accessed, or a digital content item that has been accessed at least a threshold number of times by other users with access to the flagged collaborative digital team space and that the user has not yet accessed.

Further, the series of acts 1300 includes an act 1340 of generating a digital space report. In particular, the act 1340 can involve generating a digital space report comprising content item elements for the one or more relevant digital content items. The act 1340 can involve, based on the relevance scores for the digital content items, generate a digital space report comprising content item elements for relevant digital content items within the flagged collaborative digital team space that satisfy a relevance threshold with respect to the user. The series of acts 1300 can include an act of identifying, based on the relevance scores, a first set of digital content items within the flagged collaborative digital team space that satisfy the relevance threshold with respect to the user. Further, the series of acts 1300 can include an act of identifying, based on the relevance scores, a second set of digital content items within the flagged collaborative digital team space that fail to satisfy the relevance threshold with respect to the user. Thus, the act 1340 can involve including content item elements for the first set of digital content items within the digital space report and refraining from including content item elements for the second set of digital content items within the digital space report. The act 1340 can also involve including, within the digital space report, a threshold number of content item elements corresponding to relevant digital content items that satisfy the threshold relevance with respect to the user and excluding, from the digital space report, additional content item elements corresponding to relevant digital content items whose relevance scores with respect to the user are lower than relevance scores corresponding to the included content item elements.

As further illustrated, the series of acts 1300 includes an act 1350 of providing the digital space report for display. In particular, the act 1350 can involve providing, to the client device associated with the user, the digital space report for display within a space report interface on the client device.

The series of acts 1300 can further include an act of identifying, from the plurality of collaborative digital team spaces, a second flagged collaborative digital team space selected for receiving digital content item updates. In addition, the series of acts 1300 can include an act of generating a second digital space report comprising content item elements for digital content items within the second flagged collaborative digital team space that satisfy the relevance threshold with respect to the user. Further, the series of acts 1300 can include an act of providing, for display on the client device, a multi-space report summary interface including: a first team space element representing the flagged collaborative digital team space and comprising an indicator indicating a number of relevant digital content items in the digital space report and a second team space element representing the second flagged collaborative digital team space and comprising an indicator indicating a number of relevant digital content items in the second digital space report.

The series of acts 1300 can include an act of identifying digital content items that fail to satisfy the relevance threshold with respect to the user by determining that the user has not accessed a digital content item within the flagged collaborative digital team space for at least a threshold period of time. In addition, the series of acts 1300 can include an act of determining, based on activity associated with users with access to the flagged collaborative digital team space, a user that makes the most modifications to digital content items within the flagged collaborative digital team space. The series of acts 1300 can also include an act of generating the digital space report to include a spotlight element indicating the user that makes the most modifications to digital content items within the flagged collaborative digital team space. Indeed, the act 1304 can involve generating the digital space report to include one or more spotlight elements indicating users that have performed a particular action based on monitoring the user activity.

Additionally, the series of acts 1300 can include an act of identifying a second user associated with a second client device with access to the flagged collaborative digital team space. The series of acts 1300 can further include an act of generating relevance scores relative to the second user for the digital content items within the flagged collaborative digital team space. Further, the series of acts 1300 can include an act of generating the relevance scores relative to the second user by identifying a second plurality of content relevance indicators indicating measures of relevance of digital content items with respect to the second user. The series of acts 1300 can still further include an act of generating a second digital space report for the second user and including content item elements for relevant digital content items within the flagged collaborative digital team space that satisfy a relevance threshold with respect to the second user, wherein the relevant digital content items with respect to the second user are different from the relevant digital content items with respect to the user.

The series of acts 1300 can include an act of identifying a user interaction selecting a first content item element within the space report interface and corresponding to a first digital content item and an act of identify a second content item element within the space report interface and corresponding to a second digital content item that is not selected. Further, the series of acts 1300 can include an act of modifying the weighting of the plurality of content relevance indicators to increase a likelihood of including the first content item element within a subsequent digital space report and to decrease a likelihood of including the second content item element within the subsequent digital space report.

In some implementations, the series of acts 1300 includes an act of identifying, based on the relevance scores, a first set of digital content items within the flagged collaborative digital team space that satisfy the relevance threshold with respect to the user. In these or other implementations, the series of acts 1300 includes an act of identifying, based on the relevance scores, a second set of digital content items within the flagged collaborative digital team space that fail to satisfy the relevance threshold with respect to the user. Further, the series of acts 1300 can include an act of generating the digital space report by including content item elements for the first set of digital content items within the digital space report and refraining from including content item elements for the second set of digital content items within the digital space report.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 14 illustrates a block diagram of exemplary computing device 1400 that may be configured to perform one or more of the processes described above. One will appreciate that server(s) 104, the client devices 108a-108n, and/or the computing device 1200 may comprise one or more computing devices such as computing device 1400. As shown by FIG. 14, computing device 1400 can comprise processor 1402, memory 1404, storage device 1406, I/O interface 1408, and communication interface 1410, which may be communicatively coupled by way of communication infrastructure 1412. While an exemplary computing device 1400 is shown in FIG. 14, the components illustrated in FIG. 14 are not intended to be limiting. Additional or alternative components may be used in other implementations. Furthermore, in certain implementations, computing device 1400 can include fewer components than those shown in FIG. 14. Components of computing device 1400 shown in FIG. 14 will now be described in additional detail.

In particular implementations, processor 1402 includes hardware for executing instructions, such as those making up a computer program. As an example and not by way of limitation, to execute instructions, processor 1402 may retrieve (or fetch) the instructions from an internal register, an internal cache, memory 1404, or storage device 1406 and decode and execute them. In particular implementations, processor 1402 may include one or more internal caches for data, instructions, or addresses. As an example and not by way of limitation, processor 1402 may include one or more instruction caches, one or more data caches, and one or more translation lookaside buffers (TLBs). Instructions in the instruction caches may be copies of instructions in memory 1404 or storage device 1406.

Memory 1404 may be used for storing data, metadata, and programs for execution by the processor(s). Memory 1404 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1404 may be internal or distributed memory.

Storage device 1406 includes storage for storing data or instructions. As an example and not by way of limitation, storage device 1406 can comprise a non-transitory storage medium described above. Storage device 1406 may include a hard disk drive (HDD), a floppy disk drive, flash memory, an optical disc, a magneto-optical disc, magnetic tape, or a Universal Serial Bus (USB) drive or a combination of two or more of these. Storage device 1406 may include removable or non-removable (or fixed) media, where appropriate. Storage device 1406 may be internal or external to computing device 1400. In particular implementations, storage device 1406 is non-volatile, solid-state memory. In other implementations, Storage device 1406 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1408 allows a user to provide input to, receive output from, and otherwise transfer data to and receive data from computing device 1400. I/O interface 1408 may include a mouse, a keypad or a keyboard, a touch screen, a camera, an optical scanner, network interface, modem, other known I/O devices or a combination of such I/O interfaces. I/O interface 1408 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1408 is configured to provide graphical data to a display for presentation to a user. The graphical data may be representative of one or more graphical user interfaces and/or any other graphical content as may serve a particular implementation.

Communication interface 1410 can include hardware, software, or both. In any event, communication interface 1410 can provide one or more interfaces for communication (such as, for example, packet-based communication) between computing device 1400 and one or more other computing devices or networks. As an example and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1410 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1410 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1410 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1412 may include hardware, software, or both that couples components of computing device 1400 to each other. As an example and not by way of limitation, communication infrastructure 1412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 15 is a schematic diagram illustrating environment 1500 within which one or more implementations of the digital space report system 102 can be implemented. Digital space report system 1502 may generate, store, manage, receive, and send digital content (such as digital videos). For example, digital space report system 1502 may send and receive digital content to and from client devices 1506 by way of network 1504. In particular, digital space report system 1502 can store and manage a collection of digital content. Digital space report system 1502 can manage the sharing of digital content between computing devices associated with a plurality of users. For instance, digital space report system 1502 can facilitate a user sharing a digital content with another user of digital space report system 1502.

In particular, digital space report system 1502 can manage synchronizing digital content across multiple client devices 1506 associated with one or more users. For example, a user may edit digital content using client device 1506. The digital space report system 1502 can cause client device 1506 to send the edited digital content to digital space report system 1502. Digital space report system 1502 then synchronizes the edited digital content on one or more additional computing devices.

In addition to synchronizing digital content across multiple devices, one or more implementations of digital space report system 1502 can provide an efficient storage option for users that have large collections of digital content. For example, digital space report system 1502 can store a collection of digital content on digital space report system 1502, while the client device 1506 only stores reduced-sized versions of the digital content. A user can navigate and browse the reduced-sized versions (e.g., a thumbnail of a digital image) of the digital content on client device 1506. In particular, one way in which a user can experience digital content is to browse the reduced-sized versions of the digital content on client device 1506.

Another way in which a user can experience digital content is to select a reduced-size version of digital content to request the full- or high-resolution version of digital content from digital space report system 1502. In particular, upon a user selecting a reduced-sized version of digital content, client device 1506 sends a request to digital space report system 1502 requesting the digital content associated with the reduced-sized version of the digital content. Digital space report system 1502 can respond to the request by sending the digital content to client device 1506. Client device 1506, upon receiving the digital content, can then present the digital content to the user. In this way, a user can have access to large collections of digital content while minimizing the amount of resources used on client device 1506.

Client device 1506 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1506 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1504.

Network 1504 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1506 may access digital space report system 1502.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
identifying, from a plurality of collaborative digital team spaces comprising respective collections of digital content items accessible by a client device associated with a user, a flagged collaborative digital team space;
in response to identifying the flagged collaborative digital team space, determining, based on a plurality of content relevance indicators relative to the user associated with the client device, relevance scores with respect to the user for digital content items within the flagged collaborative digital team space;
determining one or more relevant digital content items from the digital content items within the flagged collaborative digital team space based on the relevance scores of the one or more relevant digital content items satisfying a relevance threshold with respect to the user;
generating a digital space report comprising content item elements for the one or more relevant digital content items; and
providing, to the client device associated with the user, the digital space report for display within a space report interface on the client device.

2. The method of claim 1, wherein determining the relevance scores for the digital content items comprises:
identifying the plurality of content relevance indicators indicating measures of relevance of digital content items with respect to the user; and
weighting the plurality of content relevance indicators for the digital content items based on collaborative digital team space information associated with the user.

3. The method of claim 2, further comprising determining the collaborative digital team space information by one or more of monitoring user activity within the flagged collaborative digital team space or determining relationship information between the user and other users with access to the flagged collaborative digital team space.

4. The method of claim 1, further comprising:
identifying, from the plurality of collaborative digital team spaces, a second flagged collaborative digital team space selected for receiving digital content item updates;
generating a second digital space report comprising content item elements for digital content items within the second flagged collaborative digital team space that satisfy the relevance threshold with respect to the user; and
providing, for display on the client device, a multi-space report summary interface comprising:
a first team space element representing the flagged collaborative digital team space and comprising an indicator indicating a number of relevant digital content items in the digital space report; and
a second team space element representing the second flagged collaborative digital team space and comprising an indicator indicating a number of relevant digital content items in the second digital space report.

5. The method of claim 1, further comprising:
identifying, based on the relevance scores, a first set of digital content items within the flagged collaborative digital team space that satisfy the relevance threshold with respect to the user;
identifying, based on the relevance scores, a second set of digital content items within the flagged collaborative digital team space that fail to satisfy the relevance threshold with respect to the user; and
wherein generating the digital space report comprises:
including content item elements for the first set of digital content items within the digital space report; and
refraining from including content item elements for the second set of digital content items within the digital space report.

6. The method of claim 1, wherein determining the one or more relevant digital content items comprises identifying one or more of:
a digital content item that has been shared with the user by another user with access to the flagged collaborative digital team space and that the user has not yet accessed;
a digital content item that the user has shared with another user with access to the flagged collaborative digital team space and that the another user has not yet accessed; or
a digital content item that has been accessed at least a threshold number of times by other users with access to the flagged collaborative digital team space and that the user has not yet accessed.

7. The method of claim 1, further comprising identifying digital content items that fail to satisfy the relevance threshold with respect to the user by determining that the user has not accessed a digital content item within the flagged collaborative digital team space for at least a threshold period of time.

8. A system comprising:
at least one processor; and
a non-transitory computer readable medium comprising instructions that, when executed by the at least one processor, cause the system to:
identify, from a plurality of collaborative digital team spaces comprising respective collections of digital content items accessible by a client device associated with a user, a flagged collaborative digital team space selected for receiving digital content item updates;
in response to identifying the flagged collaborative digital team space, determine relevance scores for digital content items within the flagged collaborative digital team space by:
identifying a plurality of content relevance indicators indicating measures of relevance of digital content items with respect to the user; and
generating the relevance scores from the plurality of content relevance indicators for the digital content items based on collaborative digital team space information associated with the user;
based on the relevance scores for the digital content items, generate a digital space report comprising content item elements for relevant digital content items within the flagged collaborative digital team space that satisfy a relevance threshold with respect to the user; and
provide the digital space report for display within a space report interface on the client device.

9. The system of claim 8, wherein the plurality of content relevance indicators comprise two or more of: a frequency of access of a digital content item by the user, a frequency of access of the digital content item by other users with access to the flagged collaborative digital team space, a number of accesses of the digital content item by the user, a number of accesses of the digital content item by other users with access to the flagged collaborative digital team space, a relationship of the user with another user with access to the flagged collaborative digital team space, a number of shares of the digital content item, a number of comments made within the digital content item, or a number of modifications made to the digital content item.

10. The system of claim 8, further comprising instructions that, when executed by the at least one processor, cause the system to:
determine, based on activity associated with users with access to the flagged collaborative digital team space, a user that makes the most modifications to digital content items within the flagged collaborative digital team space; and
generate the digital space report to include a spotlight element indicating the user that makes the most modifications to digital content items within the flagged collaborative digital team space.

11. The system of claim 8, further comprising instructions that, when executed by the at least one processor, cause the system to:
identify a second user associated with a second client device with access to the flagged collaborative digital team space; and
generate relevance scores relative to the second user for the digital content items within the flagged collaborative digital team space.

12. The system of claim 11, further comprising instructions that, when executed by the at least one process, cause the system to:
generate the relevance scores relative to the second user by identifying a second plurality of content relevance indicators indicating measures of relevance of digital content items with respect to the second user; and
generate a second digital space report for the second user and comprising content item elements for relevant digital content items within the flagged collaborative digital team space that satisfy a relevance threshold with respect to the second user, wherein the relevant digital content items with respect to the second user are different from the relevant digital content items with respect to the user.

13. The system of claim 8, further comprising instructions that, when executed by the at least one processor, cause the system to determine the collaborative digital team space information by one or more of monitoring user activity within the flagged collaborative digital team space or determining relationship information between the user and other users with access to the flagged collaborative digital team space.

14. The system of claim 8, further comprising instructions that, when executed by the at least one processor, cause the system to:
identify a user interaction selecting a first content item element within the space report interface and corresponding to a first digital content item;
identify a second content item element within the space report interface and corresponding to a second digital content item that is not selected; and
generate the relevance scores from the plurality of content relevance indicators by weighting of the plurality of content relevance indicators to increase a likelihood of including the first content item element within a subsequent digital space report and to decrease a likelihood of including the second content item element within the subsequent digital space report.

15. A non-transitory computer readable medium comprising instructions that, when executed by at least one processor, cause a computing device to:
identify, from a plurality of collaborative digital team spaces comprising respective collections of digital content items accessible by a client device associated with a user, a flagged collaborative digital team space selected for receiving digital content item updates;
in response to identifying the flagged collaborative digital team space, determine relevance scores comprising weighted combinations of a plurality of content relevance indicators for digital content items within the collection of digital content items with respect to the user;
determine one or more relevant digital content items form the digital content items within the flagged collaborative digital team space based on the relevance scores of the one or more relevant digital content items satisfying a relevance threshold with respect to the user;
generate a digital space report comprising content item elements for the one or more relevant digital content items; and
provide the digital space report for display within a space report interface on the client device.

16. The non-transitory computer readable medium of claim 15, further comprising instructions that, when executed by the at least one processor, cause the computing device to determine the weighted combinations of the plurality of content relevance indicators by:
weighting, for each digital content item within the flagged collaborative digital team space, the plurality of content relevance indicators based on collaborative digital team space information associated with the user; and
combining the weighted plurality of content relevance indicators for each digital content item within the collection of digital content items.

17. The non-transitory computer readable medium of claim 16, further comprising instructions that, when executed by the at least one processor, cause the computing device to generate the digital space report by:
including, within the digital space report, a threshold number of content item elements corresponding to relevant digital content items that satisfy the threshold relevance with respect to the user; and
excluding, from the digital space report, additional content item elements corresponding to relevant digital content items whose relevance scores with respect to the user are lower than relevance scores corresponding to the included content item elements.

18. The non-transitory computer readable medium of claim 17, further comprising instructions that, when executed by the at least one processor, cause the computing device to:
identify, based on the relevance scores, a first set of digital content items within the flagged collaborative digital team space that satisfy the relevance threshold with respect to the user;
identify, based on the relevance scores, a second set of digital content items within the flagged collaborative digital team space that fail to satisfy the relevance threshold with respect to the user; and
generate the digital space report by:
including content item elements for the first set of digital content items within the digital space report; and
refraining from including content item elements for the second set of digital content items within the digital space report.

19. The non-transitory computer readable medium of claim 15, further comprising instructions that, when executed by the at least one processor, cause the computing device to identify the relevant digital content items that satisfy the relevance threshold with respect to the user by identifying one or more of:
a digital content item that has been shared with the user by another user with access to the flagged collaborative digital team space and that the user has not yet accessed;
a digital content item that the user has shared with another user with access to the flagged collaborative digital team space and that the another user has not yet accessed; or
a digital content item that has been accessed at least a threshold number of times by other users with access to the flagged collaborative digital team space and that the user has not yet accessed.

20. The non-transitory computer readable medium of claim 15, further comprising instructions that, when executed by the at least one processor, cause the computing device to:
monitor user activity of users with access to the flagged collaborative digital team space; and
generate the digital space report to include one or more spotlight elements indicating users that have performed a particular action based on monitoring the user activity.
